(19) United States
(12) Patent Application Publication
(10) Pub. No.: US 2024/0086032 A1
(43) Pub. Date: Mar. 14, 2024

(54) METHOD OF MANIPULATING USER INTERFACES IN AN ENVIRONMENT

(71) Applicant: Apple Inc., Cupertino, CA (US)

(72) Inventors: Alexis H. PALANGIE, Palo Alto, CA (US); Aaron M. BURNS, Sunnyvale, CA (US)

(21) Appl. No.: 18/515,191

(22) Filed: Nov. 20, 2023

Related U.S. Application Data
(63) Continuation of application No. 18/260,026, filed on Jun. 29, 2023, now abandoned.
(60) Provisional application No. 63/132,974, filed on Dec. 31, 2020.

(51) Int. Cl. G06F 3/04815; G06F 3/01; G06F 3/04842; G06F 3/04845

(52) U.S. Cl. CPC G06F 3/04815; G06F 3/013; G06F 3/017; G06F 3/04842; G06F 3/04845

(57) ABSTRACT

Methods for displaying and manipulating user interfaces in a computer-generated environment provide for an efficient and intuitive user experience. In some embodiments, user interfaces can be grouped together into a container. In some embodiments, a user interface that is a member of a container can be manipulated. In some embodiments, manipulating a user interface that is a member of a container can cause the other user interfaces in the same container to be manipulated. In some embodiments, manipulating user interfaces in a container can cause the user interfaces to change one or more orientation and/or rotate about one or more axes.

### CROSS-REFERENCE TO RELATED APPLICATIONS

This application is a continuation of U.S. application Ser. No. 18/260,026, filed Jun. 29, 2023, which is a National Phase application under 35 U.S.C. § 371 of International Application No. PCT/US2021/065242, filed Dec. 27, 2021, which claims the priority benefit of U.S. Provisional Application No. 63/132,974, filed Dec. 31, 2020, the contents of which are hereby incorporated by reference in their entireties for all intended purposes.

### FIELD OF THE DISCLOSURE

This relates generally to systems and methods for manipulating user interfaces in a computer-generated environment.

### BACKGROUND OF THE DISCLOSURE

Computer-generated environments are environments where at least some objects displayed for a user's viewing are generated using a computer. Users may interact with a computer-generated environment, such as by manipulating user interfaces of applications.

### SUMMARY OF THE DISCLOSURE

Some embodiments described in this disclosure are directed to methods of grouping user interfaces in a three-dimensional environment into containers. Some embodiments described in this disclosure are directed to methods of manipulating user interfaces in a three-dimensional environment that are members of containers. These interactions provide a more efficient and intuitive user experience. The full descriptions of the embodiments are provided in the Drawings and the Detailed Description, and it is understood that this Summary does not limit the scope of the disclosure in any way.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an electronic device displaying a computer-generated environment according to some embodiments of the disclosure.

FIG. 2 illustrates a block diagram of an exemplary architecture for a system or device in accordance with some embodiments of the disclosure.

FIG. 3 illustrates a method of displaying user interfaces in a container in a three-dimensional environment according to some embodiments of the disclosure.

FIGS. 4A-4B illustrate a method of moving user interfaces in a container according to some embodiments of the disclosure.

FIGS. 5A-5C illustrate a method of moving user interfaces in a container according to some embodiments of the disclosure.

FIGS. 6A-6B illustrate a method of moving user interfaces in a container according to some embodiments of the disclosure.

FIG. 7 is a flow diagram illustrating a method of moving user interfaces in a container in a three-dimensional environment according to some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. An XR environment is often referred to herein as a computer-generated environment. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user's eyes. The display may utilize various display technologies, such as μLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

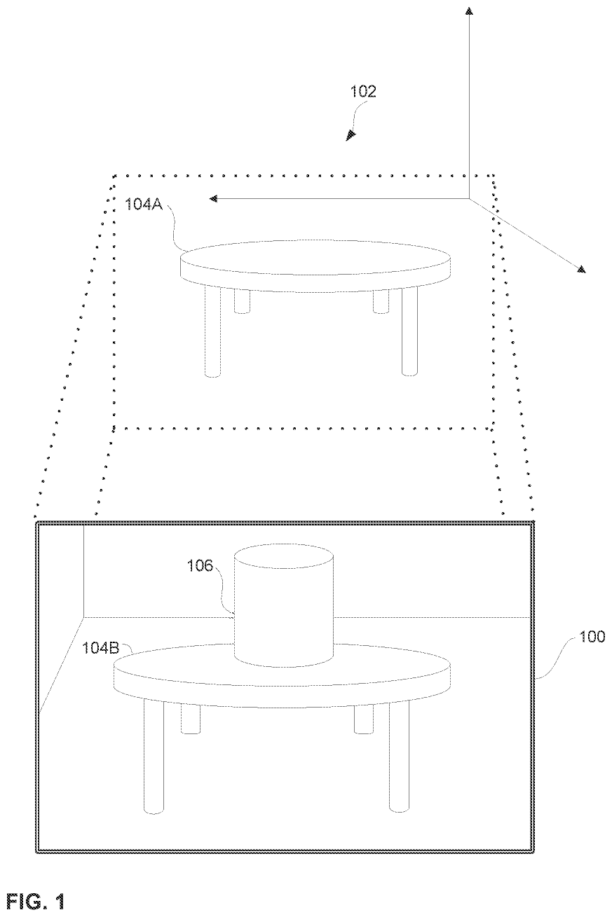

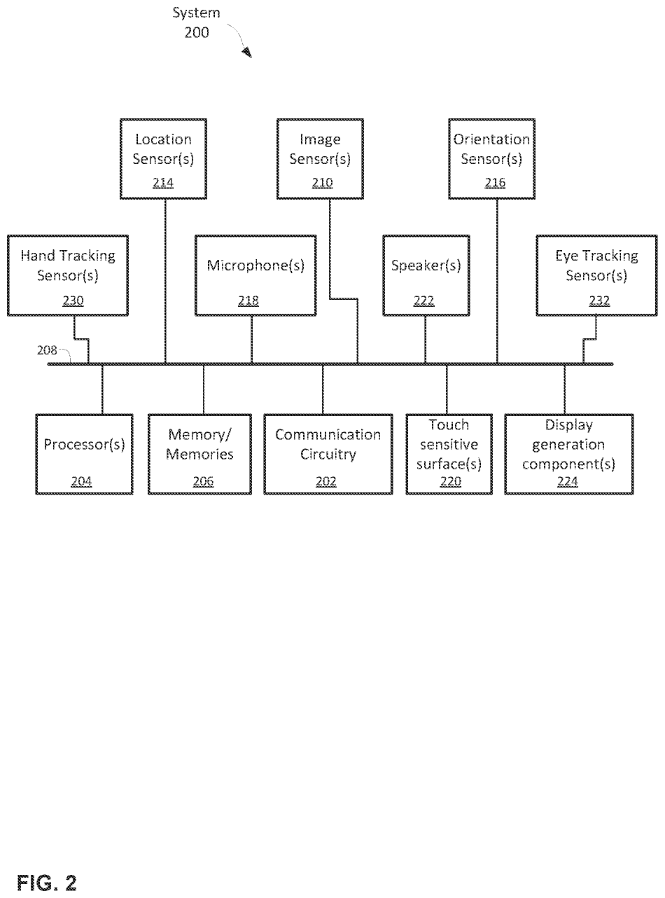

FIG. 1 illustrates an electronic device 100 displaying a computer-generated environment (e.g., an XR environment) according to some embodiments of the disclosure. In some embodiments, electronic device 100 is a hand-held or mobile device, such as a tablet computer, laptop computer, smartphone, a wearable device, or head-mounted display. Examples of device 100 are described below with reference to the architecture block diagram of FIG. 2. As shown in FIG. 1, electronic device 100 and table 104A are located in the physical environment 102. In some embodiments, electronic device 100 may be configured to capture areas of physical environment 102 including table 104A (illustrated in the field of view of electronic device 100). In some embodiments, in response to a trigger, the electronic device 100 may be configured to display an object 106 in the computer-generated environment (e.g., represented by a cylinder illustrated in FIG. 1) that is not present in the physical environment 102 (e.g., a virtual object), but is displayed in the computer generated environment positioned on (e.g., anchored to) the top of a computer-generated representation 104B of real-world table 104A. For example, object 160 can be displayed on the surface of the computer-generated representation 104B of table 104A in the computer-generated environment displayed via device 100 in response to detecting the planar surface of table 104A in the physical environment 102. It should be understood that object 106 is a representative object and one or more different objects (e.g., of various dimensionality such as two-dimensional or three-dimensional objects) can be included and rendered in a three-dimensional computer-generated environment. For example, the object can represent an application or a user interface displayed in the computer-generated environment. In some examples, the application or user interface can include the display of selectable options for launching applications or for performing operations associated with applications. Additionally, it should be understood, that the three-dimensional (3D) environment (or 3D object) described herein may be a representation of a 3D environment (or three-dimensional object) displayed in a two dimensional (2D) context (e.g., displayed on a 2D screen).

FIG. 2 illustrates a block diagram of an exemplary architecture for a system or device 200 in accordance with some embodiments of the disclosure. The blocks in FIG. 2 can represent an information processing apparatus for use in a device. It is understood that the components of system or device 200 are optionally distributed amongst two or more devices.

In some embodiments, device 200 is a mobile device, such as a mobile phone (e.g., smart phone or other portable communication device), a tablet computer, a laptop computer, a desktop computer, a wearable device, a head-mounted display, an auxiliary device in communication with another device, etc. In some embodiments, device 200, as illustrated in FIG. 2, includes communication circuitry 202, processor(s) 204, memory 206, image sensor(s) 210, location sensor(s) 214, orientation sensor(s) 216, microphone(s) 218, touch-sensitive surface(s) 220, speaker(s) 222, display generation component(s) 224, hand tracking sensor(s) 230, and/or eye tracking sensor(s) 232, among other possible components. These components optionally communicate over communication bus(es) 208 of device 200.

Communication circuitry 202 optionally includes circuitry for communicating with electronic devices, networks, such as the Internet, intranets, a wired network and/or a wireless network, cellular networks and wireless local area networks (LANs). Communication circuitry 202 optionally includes circuitry for communicating using near-field communication (NFC) and/or short-range communication, such as Bluetooth®.

Processor(s) 204 optionally include one or more general processors, one or more graphics processors, and/or one or more digital signal processors. In some embodiments, memory 206 is a non-transitory computer-readable storage medium (e.g., flash memory, random access memory, or other volatile or non-volatile memory or storage) that stores one or more programs including instructions or computer-readable instructions configured to be executed by processor(s) 204 to perform the techniques, processes, and/or methods described below. In some embodiments, memory 206 can including more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

In some embodiments, display generation component(s) 224 include a single display (e.g., a liquid-crystal display (LCD), organic light-emitting diode (OLED), or other types of display). In some embodiments, display generation component(s) 224 includes multiple displays. In some embodiments, display generation component(s) 224 can include a display with touch capability (e.g., a touch screen), a projector, a holographic projector, a retinal projector, etc. In some embodiments, device 200 includes touch-sensitive surface(s) 220 for receiving user inputs, such as tap inputs and swipe inputs or other gestures. In some embodiments, display generation component(s) 224 and touch-sensitive surface(s) 220 form touch-sensitive display(s) (e.g., a touch screen integrated with device 200 or external to device 200 that is in communication with device 200).

Image sensors(s) 210 optionally include one or more visible light image sensor, such as charged coupled device (CCD) sensors, and/or complementary metal-oxide-semiconductor (CMOS) sensors operable to obtain images of physical objects from the real-world environment. Image sensor(s) 210 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 210 also optionally include one or more cameras configured to capture movement of physical objects in the real-world environment. Image sensor(s) 210 also optionally include one or more depth sensors configured to detect the distance of physical objects from device 200. In some embodiments, information from one or more depth sensors can allow the device to identify and differentiate objects in the real-world environment from other objects in the real-world environment. In some embodiments, one or more depth sensors can allow the device to determine the texture and/or topography of objects in the real-world environment. In some embodiments, device 200 uses CCD sensors, event cameras, and depth sensors in combination to detect the physical environment around device 200. In some embodiments, image sensor(s) 210 include a first image sensor and a second image sensor. The first image sensor and the second image sensor work in tandem and are optionally configured to capture different information of physical objects in the real-world environment. In some embodiments, the first image sensor is a visible light image sensor and the second image sensor is a depth sensor. In some embodiments, device 200 uses image sensor(s) 210 to detect the position and orientation of device 200 and/or display generation component(s) 224 in the real-world environment. For example, device 200 uses image sensor(s) 210 to track the position and orientation of display generation component(s) 224 relative to one or more fixed objects in the real-world environment.

Device 200 optionally uses microphone(s) 218 or other audio sensors to detect sound from the user and/or the real-world environment of the user. In some embodiments, microphone(s) 218 includes an array of microphones (a plurality of microphones) that optionally operate in tandem, such as to identify ambient noise or to locate the source of sound in space of the real-world environment. In some embodiments, audio or voice inputs can be used to interact with the user interface or computer-generated environment captured by one or more microphones (e.g., audio sensors).

Device 200 includes location sensor(s) 214 for detecting a location of device 200 and/or display generation component(s) 224. For example, location sensor(s) 214 can include a GPS receiver that receives data from one or more satellites and allows device 200 to determine the device's absolute position in the physical world. Device 200 includes orientation sensor(s) 216 for detecting orientation and/or movement of device 200 and/or display generation component(s) 224. For example, device 200 uses orientation sensor(s) 216 to track changes in the position and/or orientation of device 200 and/or display generation component(s) 224, such as with respect to physical objects in the real-world environment. Orientation sensor(s) 216 optionally include one or more gyroscopes and/or one or more accelerometers.

Device 200 includes hand tracking sensor(s) 230 and/or eye tracking sensor(s) 232, in some embodiments. Hand tracking sensor(s) 230 are configured to track the position/location of one or more portions of the user's hands, and/or motions of one or more portions of the user's hands with respect to the computer-generated environment, relative to the display generation component(s) 224, and/or relative to another defined coordinate system. Eye tracking sensor(s) 232 are configured to track the position and movement of a user's gaze (eyes, face, or head, more generally) with respect to the real-world or computer-generated environment and/or relative to the display generation component(s) 224. In some embodiments, hand tracking sensor(s) 230 and/or eye tracking sensor(s) 232 are implemented together with the display generation component(s) 224. In some embodiments, the hand tracking sensor(s) 230 can use image sensor(s) 210 (e.g., one or more IR cameras, 3D cameras, depth cameras, etc.) that capture three-dimensional information from the real-world including one or more hands (e.g., of a human user). In some examples, the hands can be resolved with sufficient resolution to distinguish fingers and their respective positions. In some embodiments, one or more image sensor(s) 210 are positioned relative to the user to define a field of view of the image sensor(s) and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures) can be advantageous in that it does not require the user to touch, hold or wear any sort of beacon, sensor, or other marker. In some embodiments, eye tracking sensor(s) 232 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some embodiments, both eyes are tracked separately by respective eye tracking cameras and illumination sources, and a focus/gaze can be determined from tracking both eyes. In some embodiments, one eye (e.g., a dominant eye) is tracked by a respective eye tracking camera/illumination source(s). In some embodiments, eye tracking sensor(s) 232 can use image sensor(s) 210 (e.g., one or more IR cameras, 3D cameras, depth cameras, etc.).

Device 200 is not limited to the components and configuration of FIG. 2, but can include fewer, other, or additional components in multiple configurations. A person using device 200, is optionally referred to herein as a user of the device.

As described herein, a computer-generated environment including various graphics user interfaces (“GUIs”) may be displayed using an electronic device, such as electronic device 100 or device 200, including one or more display generation components. The computer-generated environment can include one or more GUIs associated with an application. Device 100 or device 200 may supports a variety of applications, such as productivity applications (e.g., a presentation application, a word processing application, a spreadsheet application, etc.), a gaming application, a telephone application, a video conferencing application, an e-mail application, an instant messaging application, a web browsing application, etc.

In some embodiments, locations in a computer-generated environment (e.g., a three-dimensional environment, an XR environment, etc.) optionally have corresponding locations in the physical environment. Thus, when a device is described as displaying a virtual object at a respective location with respect to a physical object (e.g., such as a location at or near the hand of the user, or at or near a physical table), the device displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment can interact with virtual objects that exist only in the three-dimensional environment. For example, a three-dimensional environment can include a table and a user interface located in front of the table, with the table being a view of (or a representation of) a physical table in the physical environment, and the user interface being a virtual object.

Similarly, a user is optionally able to interact with virtual objects in the three-dimensional environment (e.g., such as user interfaces of applications running on the device) using one or more hands as if the virtual objects were real objects in the physical environment. For example, as described above, one or more sensors of the device optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment (e.g., grabbing, moving, touching, pointing at virtual objects, etc.) as if they were real physical objects in the physical environment. In some embodiments, a user is able to move his or her hands to cause the representations of the hands in the three-dimensional environment to move in conjunction with the movement of the user's hand.

In some of the embodiments described below, the device is optionally able to determine the “effective” distance between physical objects in the physical world and virtual objects in the three-dimensional environment, for example, for the purpose of determining whether a physical object is interacting with a virtual object (e.g., whether a hand is touching, grabbing, holding, etc. a virtual object or within a threshold distance from a virtual object). For example, the device determines the distance between the hands of the user and virtual objects when determining whether the user is interacting with virtual objects and/or how the user is interacting with virtual objects. In some embodiments, the device determines the distance between the hands of the user and a virtual object by determining the distance between the location of the hands in the three-dimensional environment and the location of the virtual object of interest in the three-dimensional environment. For example, the one or more hands of the user can be located at a particular position in the physical world, which the device optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared against the position of the virtual object of interest in the three-dimensional environment to determine the distance between the one or more hands of the user and the virtual object. In some embodiments, the device optionally determines a distance between a physical object and a virtual object by comparing positions in the physical world (e.g., as opposed to comparing positions in the three-dimensional environment). For example, when determining the distance between one or more hands of the user and a virtual object, the device optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the device optionally performs any of the techniques described above to map the location of the physical object to the three-dimensional environment and/or map the location of the virtual object to the physical world.

In some embodiments, the same or similar technique is used to determine where and what the gaze of the user is directed to. For example, if the gaze of the user is directed to a particular position in the physical environment, the device optionally determines the corresponding position in the three-dimensional environment and if a virtual object is located at that corresponding virtual position, the device optionally determines that the gaze of the user is directed to that virtual object.

Similarly, the embodiments described herein may refer to the location of the user (e.g., the user of the device) and/or the location of the device in the three-dimensional environment. In some embodiments, the user of the device is holding, wearing, or otherwise located at or near the electronic device. Thus, in some embodiments, the location of the device is used as a proxy for the location of the user (e.g., the location of the device is the same as the location of the user and/or the location of the user can be interchangeably referred to as the location of the device). In some embodiments, the location of the device and/or user in the physical environment corresponds to a respective location in the three-dimensional environment. In some embodiments, the respective location is the location from which the “camera” or “view” of the three-dimensional environment extends. For example, the location of the device would be the location in the physical environment (and its corresponding location in the three-dimensional environment) from which, if a user were to stand at that location facing the respective portion of the physical environment displayed by the display generation component, the user would see the objects in the physical environment in the same position, orientation, and/or size as they are displayed by the display generation component of the device (e.g., in absolute terms and/or relative to each other). Similarly, if the virtual objects displayed in the three-dimensional environment were physical objects in the physical environment (e.g., placed at the same location in the physical environment as they are in the three-dimensional environment, and having the same size and orientation in the physical environment as in the three-dimensional environment), the location of the device and/or user is the position at which the user would see the virtual objects in the physical environment in the same position, orientation, and/or size as they are displayed by the display generation component of the device (e.g., in absolute terms and/or relative to each other and the real world objects).

Some embodiments described herein may refer to selection inputs as either discrete inputs or as continuous inputs. For example, a selection input can correspond to a single selection input or a selection input can be held (e.g., maintained) while performing one or more other gestures or inputs. In some embodiments, a selection input can have an initiation stage, a holding stage, and a termination stage. For example, in some embodiments, a pinch gesture by a hand of the user can be interpreted as a selection input. In this example, the motion of the hand into a pinch position can be referred to as the initiation stage and the device is able to detect that the user has initiated a selection input. The holding stage refers to the stage at which the hand maintains the pinch position. Lastly, the termination stage refers to the motion of the hand terminating the pinch position (e.g., releasing the pinch). In some embodiments, if the holding stage is less than a predetermined threshold amount of time (e.g., less than 0.1 seconds, 0.3 seconds, 0.5 seconds, 1 second, 2 seconds, etc.), then the selection input is interpreted as a discrete selection input (e.g., a single event actuating a respective user interface element), such as a mouse click-and-release, a keyboard button press-and-release, etc. In such embodiments, the electronic device optionally reacts to the discrete selection event (e.g., optionally after detecting the termination). In some embodiments, if the holding stage is more than the predetermined threshold amount of time, then the selection input is interpreted as a select-and-hold input, such as a mouse click-and-hold, a keyboard button press-and-hold, etc. In such embodiments, the electronic device can react to not only the initiation of the selection input (e.g., initiation stage), but also to any gestures or events detected during the holding stage (e.g., such as the movement of the hand that is performing the selection gesture), and/or the termination of the selection input (e.g., termination stage).

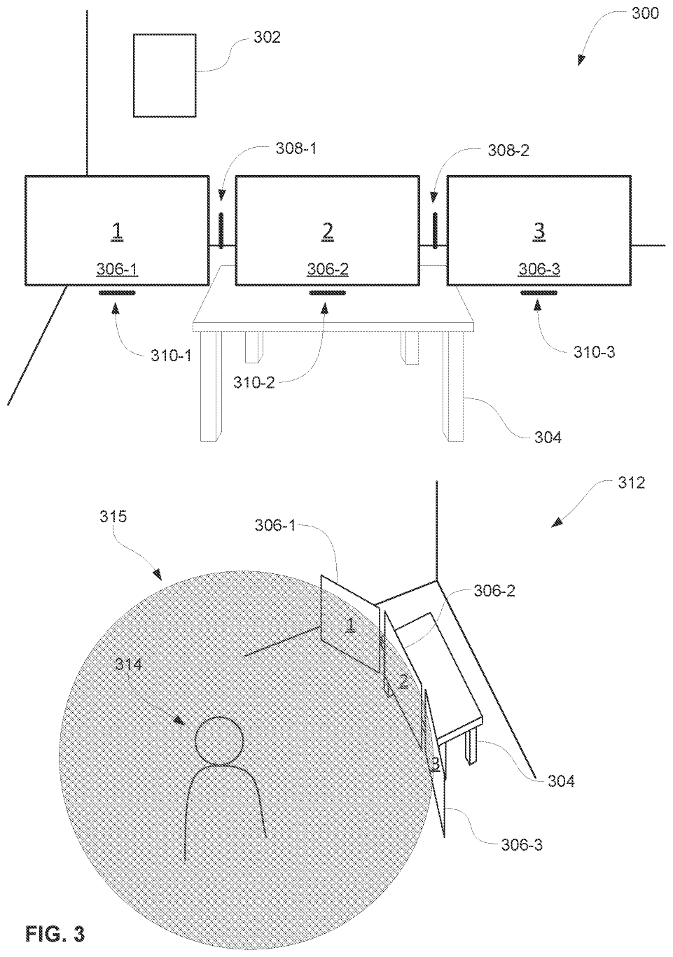

FIG. 3 illustrates a method of displaying user interfaces in a container in a three-dimensional environment according to some embodiments of the disclosure. FIG. 3 illustrates a first perspective 300 of the three-dimensional environment (e.g., an extended reality environment) and a second perspective 312 of the three-dimensional environment. In FIG. 3, first perspective 300 illustrates a view of an extended reality environment from the perspective of the user of the device. For example, first perspective 300 is the same as or similar to the view of the environment that is presented to the user and/or generated by the display generation component of a device (e.g., what is displayed by a device, such as electronic device 100 and/or device 200 described above with respect to FIG. 1 and FIG. 2, and/or how the environment looks to a user of the device). In FIG. 3, second perspective 312 illustrates an aerial view (e.g., top down view, over the top view, etc.) of the three-dimensional environment that is provided for illustrative purposes, for example, to illustrate the relative positions of elements in the three-dimensional environment.

In some embodiments, the three-dimensional environment includes one or more real-world objects (e.g., representations of objects in the physical environment around the device) and/or one or more virtual objects (e.g., representations of objects generated and displayed by the device that are not necessarily based on real world objects in the physical environment around the device). For example, in FIG. 3, table 304 and picture frame 302 can both be representations of real world objects in the physical environment around the device. In some embodiments, table 304 and picture frame 302 are displayed by the display generation component by capturing one or more images of table 304 and picture frame 302 and displaying a representation of the table and picture frame (e.g., a photorealistic representation, a simplified representation, a caricature, etc.), respectively, in the three-dimensional environment. In some embodiments, table 304 and picture frame 302 are passively provided by the device via a transparent or translucent display (e.g., by not obscuring the user's view of table 304 and picture frame 302, thus allowing table 304 and picture frame 302 to be visible).

In FIG. 3, the three-dimensional environment includes user interface 306-1, user interface 306-2, and user interface 306-3. In some embodiments, user interfaces 306-1 to 306-3 are virtual objects, for example, that exist in the three-dimensional environment but not in the real world environment. In some embodiments, user interfaces 306-1 to 306-3 are user interfaces for applications that are optionally running on the electronic device (e.g., a map application, a chat application, a browser application, etc.). For example, user interface 306-1 is a user interface for a first application, user interface 306-2 is a user interface for a second application, and user interface 306-3 is a user interface for a third application. In some embodiments, a respective application can have one user interface or a plurality of user interfaces in the three-dimensional environment (e.g., as opposed to only one user interface). In some embodiments, user interfaces 306-1, 306-2, and/or 306-3 are planar (e.g., a flat surface). In some embodiments, user interfaces 306-1, 306-2, and/or 306-3 are non-planar. For example, user interface 306-1 can be curved (e.g., curved along the horizontal axis, curved along the vertical axis), optionally with a curvature such that user interface 306-1 wraps around the user.

As shown in FIG. 3, user interfaces 306-1, 306-2, and 306-3 are located in the three-dimensional environment just in front of table 304, at a height above table 304 (e.g., such that a part of the surface of table 304 is viewable below user interface 306-2 (e.g., as shown in first perspective 300). As shown in second perspective 312, user 314 is located at a location in the three-dimensional environment facing towards user interfaces 306-1 to 306-3, table 304, and picture frame 302, such that the user is presented with a view of the environment that is the same as or similar to first perspective 300. In some embodiments, the location of user 314 is based on the actual location of the user in the real world environment. For example, if the user is located three feet in front of table 304 in the real world environment, then the device is able to determine that the user is located three feet in front of table 304 in the real world environment and place user 314 three feet in front of table 304 in the three-dimensional environment such that table 304 appears three feet away.

In some embodiments, a three-dimensional environment can include one or more containers (e.g., a set of user interfaces that move together in response to movement inputs) and one or more user interfaces can be members of the one or more containers. In FIG. 3, user interfaces 306-1, 306-2, and 306-3 are members of a container. In some embodiments, a container is optionally a user interface element that includes a set of user interfaces that have been grouped together (e.g., a set of user interfaces, a workspace, etc.). In some embodiments, user interfaces that are grouped together in a container share certain characteristics, properties, and/or behaviors with each other. For example, user interfaces in a container are automatically aligned with each other, maintain a predetermined amount of separation from each other, and/or are maintain the same distance from the user as the other user interfaces in the container, as will be described in further detail below.

In some embodiments, a three-dimensional environment can include one container or multiple containers (e.g., multiple sets of user interfaces that are grouped with each other, but optionally not necessarily with the user interfaces of other containers). In some embodiments, a three-dimensional environment can concurrently include user interfaces that are members of container(s) and user interfaces that are not members of container(s). Thus, in some embodiments, a user is able to flexibly create any number of containers and/or add or remove user interfaces from respective containers as he or she sees fit. In some embodiments, user interfaces can be automatically added to an existing container (e.g., upon launching of the application associated with the user interface) or a container can be automatically created (e.g., if another user interface is displayed in the three-dimensional environment when the respective user interface is initially displayed).

In some embodiments, as will be described in further detail below, user interfaces in a container can move together (e.g., as a single unit), for example, in response to user inputs moving one or more of the user interfaces in the container and/or moving one or more user interface elements associated with the container.

In some embodiments, user interfaces in a container have sizes and shapes based on the characteristics of the respective user interface. For example, if a first user interface in a container is associated with a first application and a second user interface in the container is associated with a second application, the size and shape of the first user interface is determined based on the design and requirements of the first application and the size and shape of the second user interface is determined based on the design and requirements of the second application. In some embodiments, whether a user interface is a member of a container (e.g., as opposed to not being a member of a container) does not affect the size and shape of a respective user interface.

In some embodiments, a container can impose size and shape restrictions on the user interfaces in the container, optionally to ensure a consistent look and feel. For example, a container can require that user interfaces in the container be less than a maximum height, be less than a maximum width, and/or have an aspect ratio within a predetermined range. It is understood that the sizes and shapes of the user interfaces illustrated herein are merely exemplary and not limiting.

In some embodiments, a visual element is displayed in the three-dimensional environment to indicate that the environment includes a container and/or to indicate that one or more user interfaces are a part of a container (e.g., are members of a container). For example, the three-dimensional environment can include a rectangular border (e.g., solid border, dashed border, etc.) surrounding the respective user interfaces, an opaque box (e.g., shaded box, patterned box, etc.) surrounding the respective user interfaces (e.g., displayed overlaid by the user interfaces of the container), etc. In some embodiments, the three-dimensional environment does not include a visual element that indicates the existence of a container.

In some embodiments, the container and/or user interfaces within the container can include one or more affordances for manipulating and/or moving the container and/or the user interfaces in the container. For example, in FIG. 3, affordance 310-1 is associated with user interface 306-1, affordance 310-2 is associated with user interface 306-2, and affordance 310-3 is associated with user interface 306-3. As shown in FIG. 3, affordances 310-1, 310-2, and 310-3 are horizontal bars, but this is merely exemplary, and affordances 310-1, 310-2, and 310-3 can have any suitable visual characteristic. For example, affordances 310-1, 310-2, and 310-3 can be an icon, a button, a manipulator element, a textual label, or any other suitable visual element.

In some embodiments, affordance 310-1 is displayed below user interface 306-1 and centered with user interface 306-1, affordance 310-2 is displayed below user interface 306-2 and centered with user interface 306-2, and affordance 310-3 is displayed below user interface 306-3 and centered with user interface 306-3, as shown in FIG. 3. In some embodiments, affordances 310-1, 310-2, and 310-3 are displayed only if and/or when the focus is on the respective user interface. In some embodiments, the focus is on a respective user interface if the user's gaze is directed to the respective user interface. For example, if the gaze of the user is directed to user interface 306-1 (e.g., looking at user interface 306-1, or looking at a location that is within a threshold distance from user interface 306-1, such as 1 inch, 6 inches, 1 foot, 3 feet, etc.), affordance 310-1 is displayed. In some embodiments, affordances 310-1, 310-2, and 310-3 are displayed if and/or when the user's gaze is directed to any of the user interfaces in the container. In some embodiments, the focus is on a respective user interface if a user reaches with a hand towards (e.g., within a threshold distance of) and/or in the direction of the respective user interface. In some embodiments, affordances 310-1, 310-2, and 310-3 are not displayed (e.g., are hidden) if the focus of the user is not directed at the respective user interface (or optionally any user interface in the container). In some embodiments, affordances 310-1, 310-2, and 310-3 are always displayed (e.g., without regard to whether the focus is on the respective user interface or any user interface in the container).

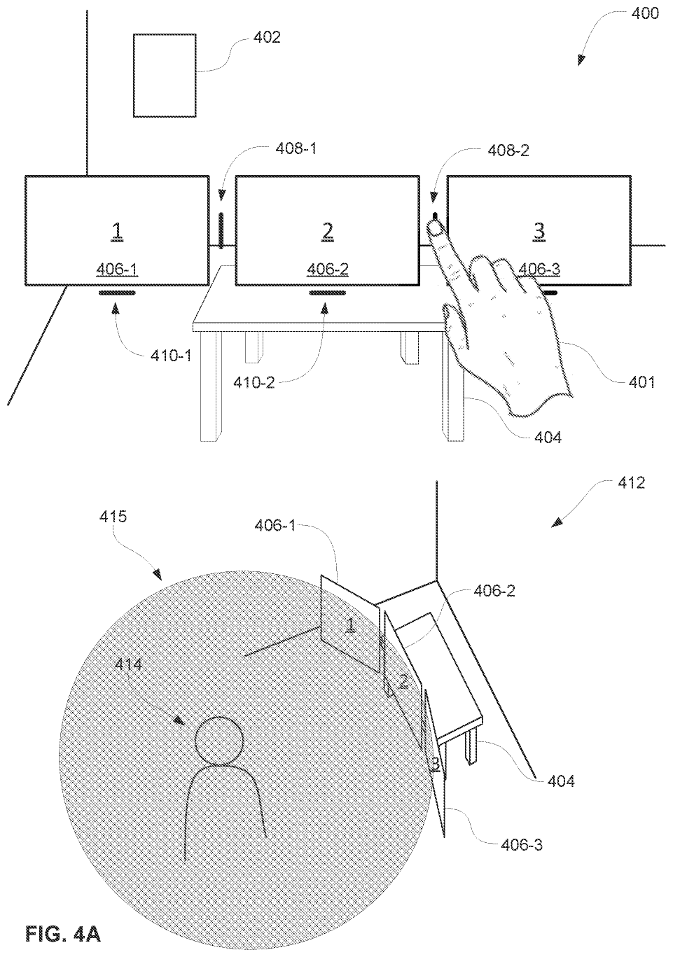

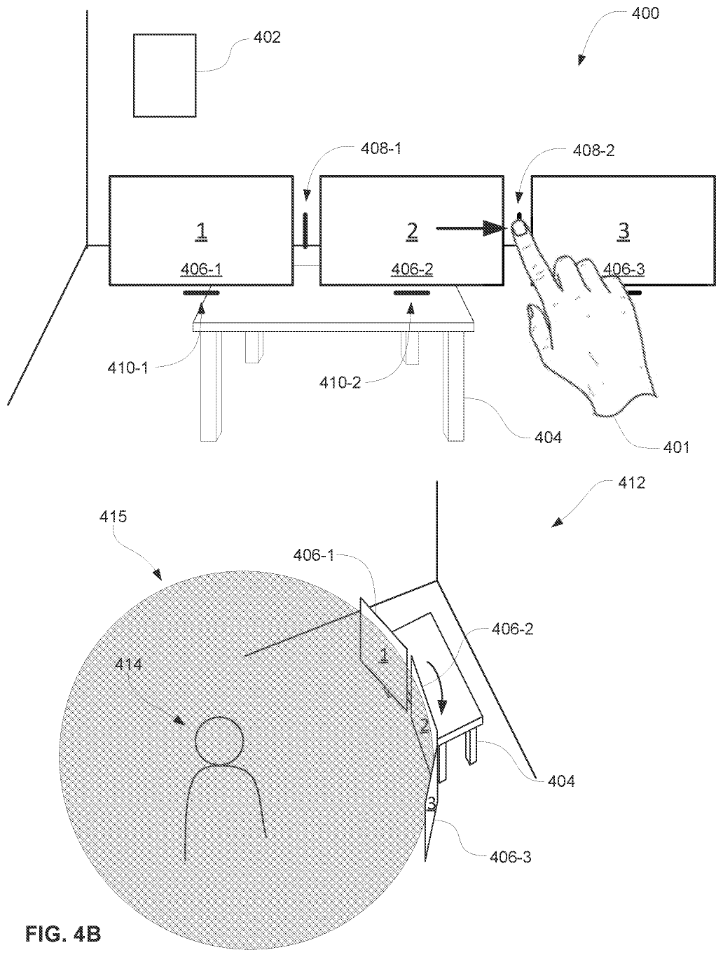

In some embodiments, user interfaces can have accompanying manipulation affordances (e.g., such as affordances 310-1, 310-2, and 310-3) without regard to whether the respective user interfaces are a part of a container. For example, if user interface 306-1 were not a member of a container, user interface 306-1 can still be accompanied by affordance 310-1 (e.g., displayed with user interface 306-1 if the criteria for displaying the affordance are satisfied). In such embodiments, affordance 310-1 is manipulable to change the position of user interface 306-1. For example, when user interface 306-1 is not a part of a container, a user is able to select affordance 310-1 with a hand (e.g., by tapping on affordance 310-1 and/or by pinching on affordance 310-1), and while selecting affordance 310-1, move the hand to cause affordance 310-1 and/or user interface 306-1 to move in accordance with the movement of the hand (e.g., in the same direction, at the same speed, and by the same amount as the movement of the hand, and/or in a direction, speed, and amount that is based on the direction, speed, and amount, respectively, of the movement of the hand), without causing the other affordances and/or user interfaces (e.g., affordances 310-2 and 310-3 and user interfaces 306-2 and 306-3) to move in accordance with the movement of the hand (e.g., the affordances and user interfaces are optionally not moved). However, when user interfaces 306-1, 306-2, and 306-3 are members of the same container, then manipulating affordance 310-1 can cause the other affordances and/or user interfaces in the container to be manipulated in the same way as affordance 310-1 and user interface 306-1, as will be described in more detail below with respect to FIGS. 4A-4B, FIGS. 5A-5C, and FIGS. 6A-6B.

In some embodiments, when a user interface is a member of a container, one or more affordances can be displayed to the left of, right of, and/or between user interfaces in the container. For example, in FIG. 3, the three-dimensional environment includes affordance 308-1 displayed between user interfaces 306-1 and 306-2, and affordance 308-2 is displayed between user interfaces 306-2 and user interface 306-3. As shown in FIG. 3, affordances 308-1 and 308-2 are vertical bars, but this is merely exemplary, and affordances 308-1 and 308-2 can have any suitable visual characteristic. For example, affordances 308-1 and 308-2 can be an icon, a button, a manipulator element, a textual label, or any other suitable visual element.

In some embodiments, additional affordances similar to affordances 308-1 and 308-2 can be displayed to the left of user interface 306-1 and/or to the right of user interface 306-3. In some embodiments, if a container includes a plurality of user interfaces, vertical affordances (e.g., such as affordances 308-1 and 308-2) are displayed between each user interface (e.g., optionally without displaying vertical affordances to the left and right of the left-most and right-most user interface, respectively), but if a container includes a single user interface, vertical affordances (e.g., such as affordances 308-1 and 308-2) are displayed to the left and right of the single user interface. In some embodiments, if a user interface is not a member of a container, then no manipulation affordances (e.g., vertical affordances such as affordances 308-1 and 308-2) are displayed adjacent to the respective user interface. Thus, in some embodiments, manipulation affordances such as affordances 308-1 and 308-2 are associated with containers (e.g., only associated with containers) and optionally not available if the three-dimensional environment does not include any containers.

In some embodiments, similarly to affordances 310-1, 310-2, and 310-3 described above, affordances 308-1 and 308-2 can be hidden and displayed only if and/or when the focus is on an adjacent user interface and/or on the location associated with a respective affordance (e.g., when the user's gaze is looking at an adjacent user interface or the location of the respective affordance or within a threshold distance of an adjacent user interface or the location of the respective affordance and/or when the user reaches for and/or points to the location of the adjacent user interface and/or respective affordance) and/or when the focus is on any user interface in the container (e.g., when the user's gaze is looking at any user interface in the container). In some embodiments, affordances 308-1 and 308-2 are always displayed (e.g., without regard to whether the focus is on an adjacent user interface or any user interface in the container). In some embodiments, affordances 310-1, 310-2, and 310-3 are associated with the container (e.g., as opposed to individual user interfaces), and thus, manipulating affordances 310-1, 310-2, and/or 310-3 causes the container to be manipulated (e.g., optionally causing the user interfaces in the container to be manipulated), as will be described in further detail below.

In some embodiments, as will be described in further detail below, a respective affordance (e.g., affordances 310-1, 310-2, and 310-2, and/or affordances 308-1 and 308-2) can be manipulated by a user to move a respective user interface or move the container (e.g., move the user interfaces of the container). In some embodiments, manipulating an affordance associated with a respective user interface causes the entire container to also be manipulated (e.g., causing the other user interfaces in the container to be manipulated in the same or a similar way). In some embodiments, manipulating an affordance associated with a respective user interface causes the respective user interface to be manipulated, but does not cause other user interfaces in the same container to be manipulated.

As illustrated by second perspective 312 in FIG. 3, user interface 306-1, user interface 306-2, and user interface 306-3 are optionally located along the surface of sphere 315 that surrounds user 314. In some embodiments, user interface 306-1, user interface 306-2, and user interface 306-3 are located along the surface of sphere 315 because they are members of the same container. Sphere 315 is optionally associated with the container of which user interfaces 306-1, 306-2, and 306-3 are members. In some embodiments, user interface 306-1, user interface 306-2, and user interface 306-3 are not automatically located along the surface of sphere 315 if they are not members of the same container. In some embodiments, if multiple containers exist in the three-dimensional environment, the three-dimensional environment includes multiple spheres similar to sphere 315. Thus, in some embodiments, each container can have an associated sphere that determines the position and/or orientation of the user interfaces in the container.

In some embodiments, sphere 315 is not displayed (e.g., a user cannot see sphere 315) and exists in the three-dimensional environment (e.g., as a software element) for the purpose of determining the location and/or orientation of the user interfaces in a container, as will be described in further detail below. In some embodiments, user 314 is centered in sphere 315. In some embodiments, user 314 is not centered in sphere 315. Sphere 315 can be a perfect sphere, an oblong sphere, an elliptical sphere, or any suitable circular and/or spherical shape (e.g., optionally a three-dimensional sphere, or a two dimensional circle). In some embodiments, user 314 is located at the focal point of sphere 315 (e.g., the focus, the location at which normal vectors extending inwards from at least a portion of the surface of sphere 315 is pointed, etc.).

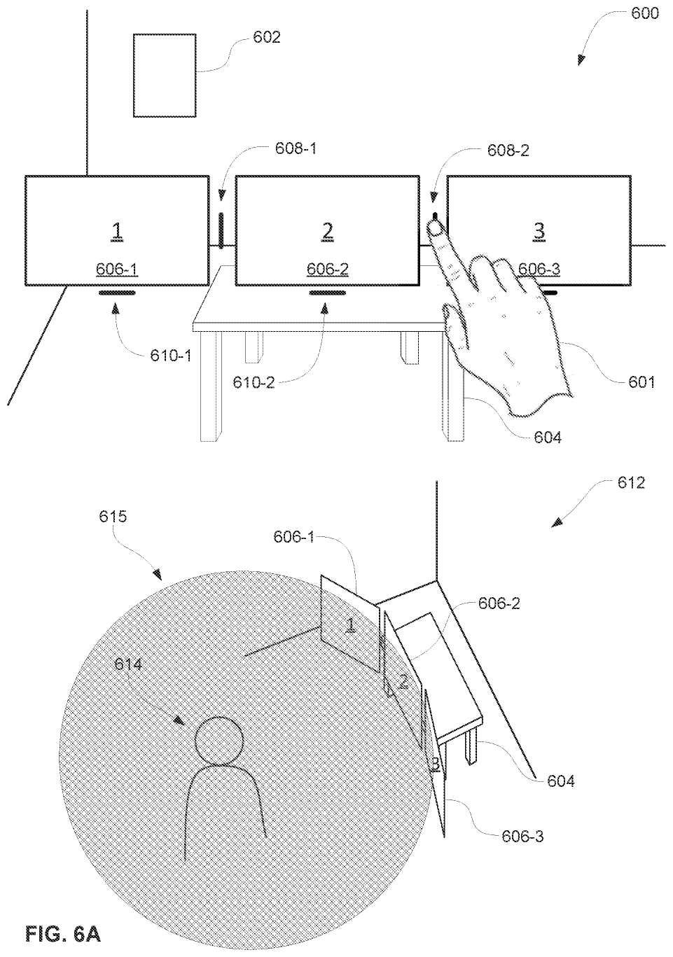

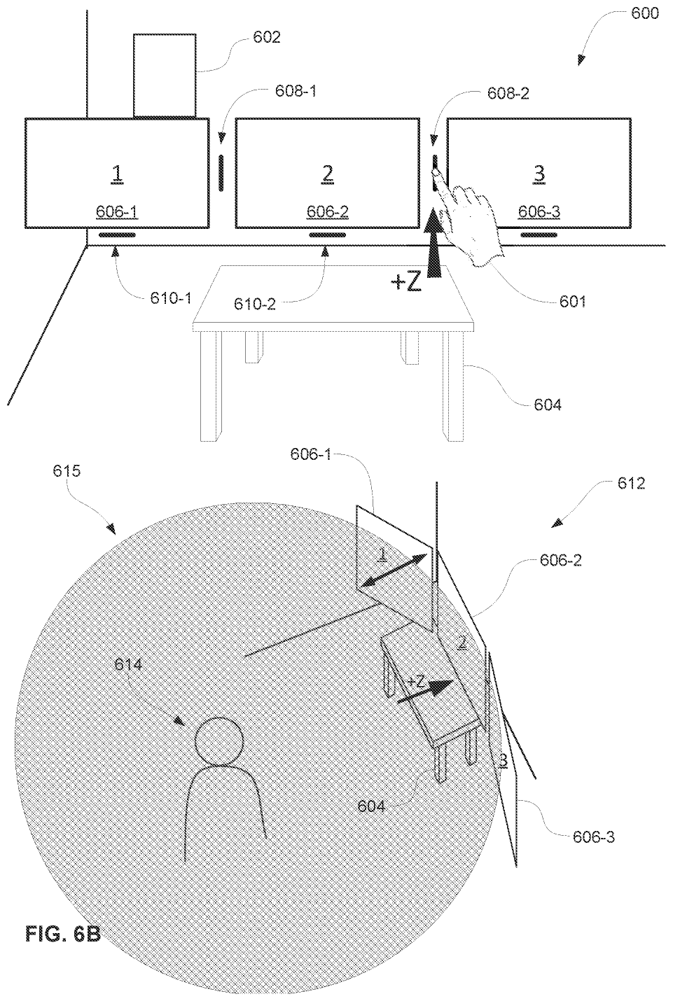

In some embodiments, the radius of sphere 315 is based on the distance of the respective user interfaces from the user. For example, if a user interface in the container (e.g., such as user interface 306-1, 306-2, and/or 306-3) is located two feet in front of user 314 when the container was created (e.g., manually set by the user to be two feet away, automatically set by the device to be two feet away, etc.), then the radius of sphere 315 is two feet. In some embodiments, due to being placed on the surface of sphere 315, user interfaces 306-1, 306-2, and 306-3 are the same distance from user 314 (e.g., in the example described above, each user interface is 2 feet away from user 314). In some embodiments, as will be described in further detail below with respect to FIGS. 6A-6B, the radius of sphere 315 can be changed such as to move user interfaces 306-1, 306-2, and 306-3 closer or farther away from user 314.

In some embodiments, the orientation of the user interfaces is based on the surface of the sphere on which the user interfaces are located. For example, if a user interface is located on the surface of sphere 315 directly in front of user 314, the user interface is oriented perpendicularly (e.g., the normal angle for the user interface is pointed horizontally toward user 314), but if the user interface is located on the surface of sphere 315 at a height above user 314, then the user interface is oriented such that it is facing diagonally downwards (e.g., the normal angle for the user interface is pointed downwards toward user 314). Similarly, if the user interface is located directly above user 314, then the user interface is oriented in parallel to the ground (e.g., the normal angle for the user interface is pointed vertically downwards toward user 314). Thus, in some embodiments, the orientation of a user interface is determined such that the normal angle of the user interface is the same as the normal angle of the location on the surface of the sphere on which the user interface is located. For example, the normal angle of the user interface has the same orientation as an imaginary line drawn from the location on the surface of sphere 315 on which the user interface is located to the focal point of sphere 315 (e.g., the center of sphere 315).

In some embodiments, locating user interfaces on the surface of sphere 315 that surrounds user 314 causes the user interfaces to automatically face towards user 314 because user 314 is located at the focal point of sphere 315 (e.g., the focus of the sphere, the point where rays extending at a normal angle inwards from at least the portion of the sphere on which the user interfaces are located converge, etc.). As will be described in further detail below, when the user interfaces in the container are moved around in the three-dimensional environment, the user interfaces remain located on the surface of sphere 315 (e.g., the user interfaces move along the surface of sphere 315 and/or sphere 315 changes size) and continue to be pointed towards user 314.

In some embodiments, user interface 306-1, user interface 306-2, and user interface 306-3 are oriented facing toward the user such that user interfaces 306-1 to 306-3 appear to be facing forward from the perspective of the user of the device (e.g., user 314), as shown in first perspective 300. For example, because user interface 306-2 is optionally directly in front of user 314 and facing directly toward user 314, user interface 306-2 appears parallel to the user (e.g., not at an oblique angle). Similarly, because user interface 306-2 is optionally facing directly toward user 314, even though user interface 306-1 is not directly in front of user 314, user interface 306-1 appears parallel to the user (e.g., not at an oblique angle). Thus, if user 314 were to turn to face toward user interface 306-1 (e.g., by turning his or her head, or turning his or her body toward user interface 306-1), then the user's view of the three-dimensional environment shifts leftwards such that user interface 306-1 located in front of the field of view of user 314 (e.g., directly in front of the field of view of user 314, in the center of the field of view of user 314, etc.) and would appear parallel to the user without requiring user interface 306-1 to change orientation within the three-dimensional environment to achieve a parallel angle. For example, if user interface 306-1 was not placed on the surface of sphere 315 and had the same orientation as user interface 306-2 (e.g., was aligned with user interface 306-2), then if the user were to turn towards user interface 306-1, the left edge of user interface 306-1 would appear farther away from the right edge of user interface 306-1 (e.g., due to being located farther from the user than the right edge of user interface 306-1). In such embodiments, in order for user interface 306-1 to appear to be facing the user, user interface 306-1 would have to change its orientation to be parallel to the user. Thus, by placing user interfaces 306-1, 306-2, and 306-3 along the surface of sphere 315 such that the orientation of the user interfaces is automatically facing towards the user, all portions of the user interfaces are equidistant to the user.

In some embodiments, if the user does not turn his or her head and/or body and instead looks to the left towards user interface 306-1 or to the right towards user interface 306-3 (e.g., or if the user looks at user interface 306-1 and/or user interface 306-3 from the periphery of the user's vision), then the outside portions of user interface 306-1 (e.g., the left side of user interface 306-1) and user interface 306-3 (e.g., the right side of user interface 306-3) may appear to be closer to the user than the inside portions of user interface 306-1 (e.g., the right side of user interface 306-1) and user interface 306-3 (e.g., the left side of user interface 306-3) due to the orientation of the user interfaces being oriented to be facing the user. For example, because user interface 306-1 and user interface 306-3 are facing towards user 314, the outside portions of user interface 306-1 and user interface 306-3 have a closer z-depth than the inner portions of user interface 306-1 and user interface 306-3, as shown in second perspective 312, even though all portions of user interface 306-1 and user interface 306-3 are equidistant to user 314 (e.g., due to user 314 being a particular location in the three-dimensional environment rather than a plane that extends across a z position). In such embodiments, while the user is facing user interface 306-2, the user may be able to perceive that user interfaces 306-1 and 306-3 are not parallel to and do not have the same orientation as user interface 306-2.

FIGS. 4A-4B illustrate a method of moving user interfaces in a container according to some embodiments of the disclosure. FIG. 4A illustrates first perspective 400 and second perspective 412 of a three-dimensional environment that includes elements similar to those described above with respect to FIG. 3, the details of which are not repeated here.

In FIG. 4A, a gesture is detected from hand 401 corresponding to a selection of affordance 408-2 (e.g., a selection gesture performed by hand 401). In some embodiments, hand 401 is the hand of the user of the device (e.g., user 414) or a representation of the hand of the user of the device. In some embodiments, a selection gesture can include a forward pointing gesture with a finger of hand 401 pointing at affordance 408-2 (e.g., a forward movement by hand 401 and/or an extension of one or more fingers towards affordance 408-2), a tap gesture with a finger of hand 401 (e.g., a forward movement by a finger of hand 401 towards affordance 408-2 such that the finger touches affordance 408-2 or approaches within a threshold distance of affordance 408-2), a pinch gesture by two or more fingers of hand 401 (e.g., a pinch by a thumb and forefinger of hand 401 at a location associated with affordance 408-2), a pinch gesture by two or more fingers of hand 401 (e.g., a pinch by a thumb and forefinger of hand 401) while gazing at affordance 408-2, or any other suitable gesture indicative of the user's interest in affordance 408-2. In some embodiments, in response to detecting the selection gesture directed to affordance 408-2, affordance 408-2 is selected, thus enabling manipulation of one or more user interfaces of the container, all user interfaces of the container, and/or the container itself, as will be described in further detail below.

As shown in FIG. 4A, affordances 408-1 and 408-2 are vertical bars placed between user interfaces in the same container. As described above with respect to affordances 308-1 and 308-2 in FIG. 3, affordances 408-1 and 408-2 are associated with the container and are optionally not associated with any particular user interface in the container. Thus, manipulating affordance 408-2 can cause the container to be manipulated (e.g., as opposed to manipulating individual user interfaces, without manipulating the container or the other user interfaces of the container), which optionally includes manipulating the one or more of the user interfaces in the container (e.g., optionally all of the user interfaces, some of the user interfaces, a subset of the user interfaces, etc.).

In FIG. 4B, the device detects that hand 401 has laterally moved rightwards in the real world environment while maintaining the selection input that is selecting affordance 408-2. In some embodiments, maintaining the selection input includes maintaining the forward pointing gesture with the finger of hand 401 pointing at affordance 408-2, maintaining the press-down position of the tap gesture with the finger of hand 401, and/or maintaining the closed position of the pinch gesture by two or more fingers of hand 401, etc. In some embodiments, in response to detecting the rightward movement of hand 401, affordance 408-2 and user interfaces 406-1, 406-2, and 406-3 are moved rightwards in accordance with the movement of hand 401 (e.g., optionally while and/or concurrently with the movement of hand 401), as shown in FIG. 4B. In some embodiments, affordance 408-2 and user interfaces 406-1, 406-2, and 406-3 move by the same amount and the amount of movement is based on the amount of movement of hand 401. For example, if hand 401 moved rightwards by 6 inches, then affordance 408-2 and user interfaces 406-1, 406-2, and 406-3 moved rightwards by 6 inches (e.g., optionally if the interaction is a direct manipulation interaction). In some embodiments, the amount that affordance 408-2 and/or user interfaces 406-1, 406-2, and 406-3 are moved is a scaled amount of the amount that hand 401 moved (e.g., scaled by a factor of 2, 3, 4, ½, etc.), for example, if the interaction is an indirect manipulation interaction. For example, if hand 401 moved rightwards by 6 inches, then affordance 408-2 and user interfaces 406-1, 406-2, and 406-3 can move rightwards by 12 inches (e.g., scaled by a factor of 2).

Thus, in some embodiments, the movement of hand 401 (e.g., while maintaining the selection gesture) causes affordance 408-2 to move with the movement of hand 401 (e.g., affordance 408-2 moves with the movement of hand 401 to stay at the same position relative to the position of hand 401) and causes the user interfaces in the container to move accordingly. As shown in FIG. 4B, the spacing between the user interfaces are optionally maintained during the movement and after the movement is completed (e.g., the user interfaces move by the same amount). In some embodiments, affordances 410-1, 410-2, and 410-3 move in accordance with the movement of their respective associated user interfaces and affordance 408-1 moves in accordance with the movement of its adjacent user interfaces (e.g., to maintain its relative position between user interface 406-1 and user interface 406-2).

In some embodiments, because user interfaces 406-1, 406-2, and 406-3 are a part of a container and are positioned on the surface of a sphere around the user (e.g., sphere 415, which is similar to sphere 315 described above with respect to FIG. 3), when user interfaces 406-1, 406-2, and 406-3 are moved around in the three-dimensional environment, the movement of user interfaces 406-1, 406-2, and 406-3 are constrained by sphere 415. Second perspective 412 illustrates that the movement of user interfaces 406-1, 406-2, and 406-3 optionally includes a rotation of the user interfaces around a focal point (e.g., the location of user 414). For example, user interfaces 406-1, 406-2, and 406-3 rotated around the surface of sphere 415 (e.g., along the surface of sphere 415) and optionally changed orientations such that the user interfaces remained at the same distance away from user 414, and remained facing user 414 (e.g., the normal vector of the user interfaces continues to be pointed toward user 414). Thus, as shown in FIG. 4B, moving the container horizontally causes the user interfaces in the container to rotate in a circular fashion around the user along the surface of sphere 415. In some embodiments, when user interfaces 406-1, 406-2, and 406-3 are a part of a container and are positioned on the surface of a sphere around the user, the amount that affordance 408-2 and/or user interfaces 406-1, 406-2, and 406-3 are moved is based on an angular displacement of hand 401 relative to the user. For example, if hand 401 moved rightwards by 45 degrees relative to the user's forward facing vector, then affordance 408-2 and user interfaces 406-1, 406-2, and 406-3 can move along the surface of sphere 415 by 45 degrees to the right. In another example, if hand 401 moved rightwards by 60 degrees relative to the user's forward facing vector, then affordance 408-2 and user interfaces 406-1, 406-2, and 406-3 can move along the surface of sphere 415 by 30 degrees to the right (e.g., the movement scaled down by a factor of 2).

In some embodiments, the movement of the user interfaces includes a movement component (e.g., moving to a new location in the three-dimensional environment, which optionally includes an x-axis movement (e.g., horizontal position) and a z-axis movement (e.g., depth) movement), and an angular rotation component (e.g., a change in the orientation of the user interface). For example, in FIG. 4B, user interface 406-1 moved in the +x direction (e.g., rightwards), moved in the +z direction (e.g., moved closer to table 404 in the z-axis) and changed orientation (e.g., rotated to a shallower angle from facing more rightwards to facing slightly rightwards), optionally all while maintaining the same distance from user 414; user interface 406-2 moved in the +x direction (e.g., rightwards), moved in the −z direction (e.g., moved farther away from table 404 in the z-axis) and changed orientation (e.g., rotated from being facing directly forward to facing slightly leftwards), optionally all while maintaining the same distance from user 414; and user interface 406-3 moved in the +x direction (e.g., rightwards), moved in the −z direction (e.g., moved farther away from table 404 in the z-axis) and changed orientation (e.g., rotated from being facing slightly leftwards to facing more leftwards), optionally all while maintaining the same distance from user 414. As illustrated by second perspective 412, the user interfaces 406-1, 406-2, and 406-3 move along the surface of sphere 415 and thus, the movement is determined by the size and shape of sphere 415.

In some embodiments, the change in the orientation of the user interface includes a rotation in the yaw dimension (e.g., rotating about the y-axis, rotating the left and right portions of the user interface around the center of the user interface while the center of the user interface does not rotate, such that the left and right parts of the user interface move closer or farther in the z-axis (e.g., depth), optionally without moving in the y-axis (e.g., vertical position) or x-axis (e.g., horizontal position)). In some embodiments, the change in the orientation of a respective user interface is based on the amount of horizontal movement and/or the distance of the user interface from the user (e.g., how much the user interface moves along the surface of sphere 415 and/or the radius of sphere 415).

For example, if affordance 408-2 is moved horizontally by a first amount, user interface 406-3 moves horizontally by the first amount and is rotated by a first respective amount, but if affordance 408-2 is moved horizontally by a second, larger amount, user interface 406-3 moves horizontally by the second amount and is rotated by a second respective amount that is greater than the first respective amount. Similarly, if user interfaces 406-1, 406-2, and 406-3 are a first distance away from the user, then in response to moving affordance 408-2 horizontally by a first amount, user interface 406-3 moves by the first amount and rotates by a first respective amount, but if user interfaces 406-1, 406-2, and 406-3 are a second, farther distance away from the user, then in response to moving affordance 408-2 horizontally by a first amount, user interface 406-3 moves by the first amount and rotates by a second respective amount that is less than the first respective amount. As described above, in some embodiments, because the user interfaces move along the surface of a sphere around the user, the amount that a respective user interfaces rotates is based on its movement along the surface of a sphere that surrounds the user and the radius of the sphere. In some embodiments, user interfaces 406-1, 406-2, and 406-3 move by the same amount as each other and/or rotate by the same amount as each other (e.g., the orientation of the user interfaces change by the same amount).

In some embodiments, the amount that a user interface rotates (e.g., in the yaw orientation) can be expressed as an angular rotation (e.g., the amount of angular change, where 180 degrees is equal to a half circle rotation of a user interface such that it is now facing in the opposite direction as before, and 360 degrees is a full circular rotation of a user interface such that it is facing in the same direction as before). In some embodiments, because the user interfaces move along the surface of a sphere, the amount that the user interfaces are rotated can be based on the angular movement of the user interfaces along the surface of the sphere. The angular movement of an object along the surface of a sphere can be determined based on the angle formed between a first line extending from the center of the sphere to the initial position to the object and a second line extending from the center of the sphere to the final position of the object. For example, a 90 degree angular movement of an object can refer to the movement of the object from directly ahead of the user to directly to the left or right of the user, and a 180 degree angular movement of an object can refer to the movement of the object from directly ahead of the user to directly behind the user. In some embodiments, the angular rotation of a user interface when it rotates along the surface of sphere 415 is the same as or based on the angular movement of the user interface. For example, if the angular movement of a user interface is 90 degrees (e.g., the user interface moved from directly in front of the user to directly to the right of the user), then the user interface is rotated by 90 degrees (e.g., from facing directly inwards from in front of the user to facing directly leftwards from the right of the user). In some embodiments, the user interface rotates in such a way and by a respective amount to continue facing towards the user (e.g., the normal vector of the user interface continues to be pointed toward the user). In some embodiments, moving along the surface of sphere 415 and having an orientation that is based on the location of the sphere on which the user interface is located ensures that the user interface has an orientation such that it faces user 414 (e.g., while moving along the surface of sphere 415).

In some embodiments, not every user interface in a container moves by the same amount as described above. For example, in response to a rightward movement of hand 401, user interface 406-3 can move by a different amount than the amount that user interface 406-2 moves (e.g., more or less), and/or user interface 406-2 can move by a different amount than the amount that user interface 406-1 moves (e.g., more or less). Thus, in some embodiments, the user interfaces are not rotated by the same amount (e.g., the spacing between the user interface optionally change when the container is rotated).

Thus, as described above, in some embodiments, moving affordance 408-2 horizontally can cause the user interfaces in the respective container to move horizontally in accordance with the amount of movement of affordance 408-2. The same behavior optionally applies to affordance 408-1, which is located between user interface 406-1 and user interface 406-2.

In some embodiments, affordance 408-1 and/or affordance 408-2 (e.g., the vertical affordances between the user interfaces in the container) are used only for horizontal movements (e.g., to move the user interfaces and/or container along the x-axis as shown in FIGS. 4A-4B). For example, in response to detecting a vertical movement or a change in the z-position of hand 401 (e.g., while maintaining the selection gesture), affordance 408-2 does not move vertically or change depth (e.g., z-position) in response to the vertical movement and/or change in the z-position, respectfully. In some embodiments, if the movement of hand 401 includes a horizontal component (e.g., such as in FIGS. 4A-4B), then affordance 408-2 (e.g., and thus, the user interfaces) can move in accordance with the horizontal component of the movement of hand 401.

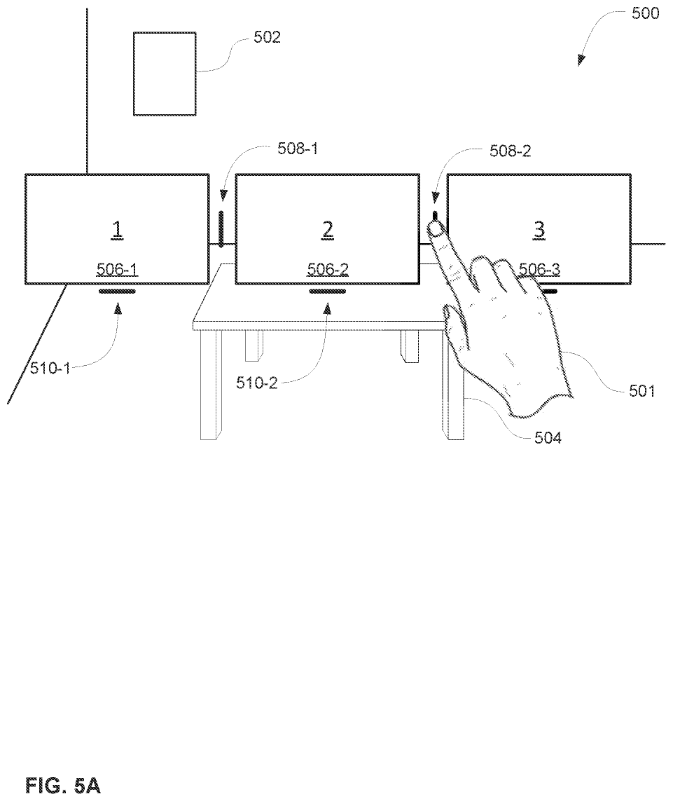

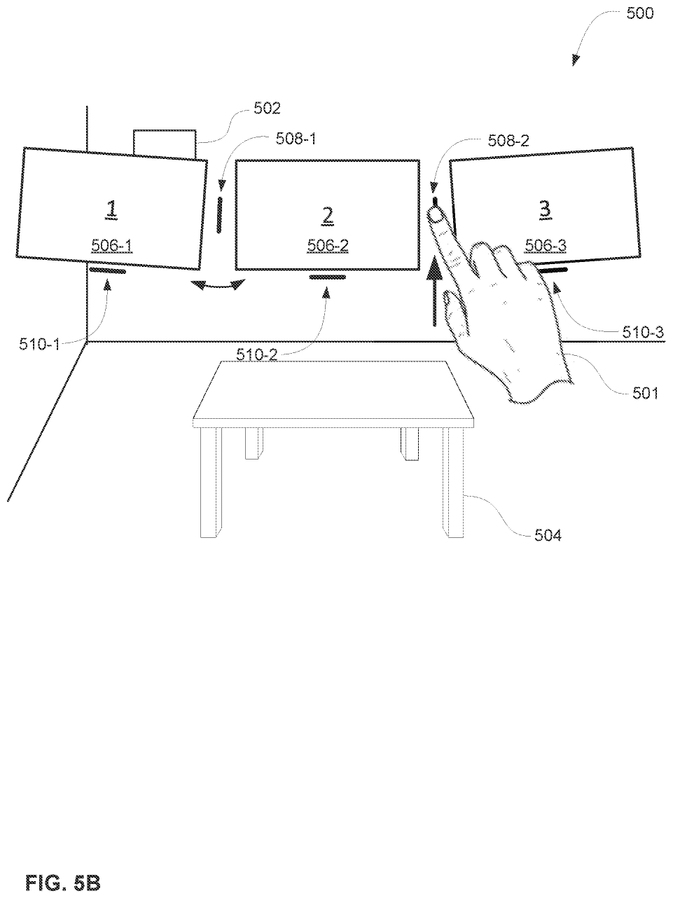

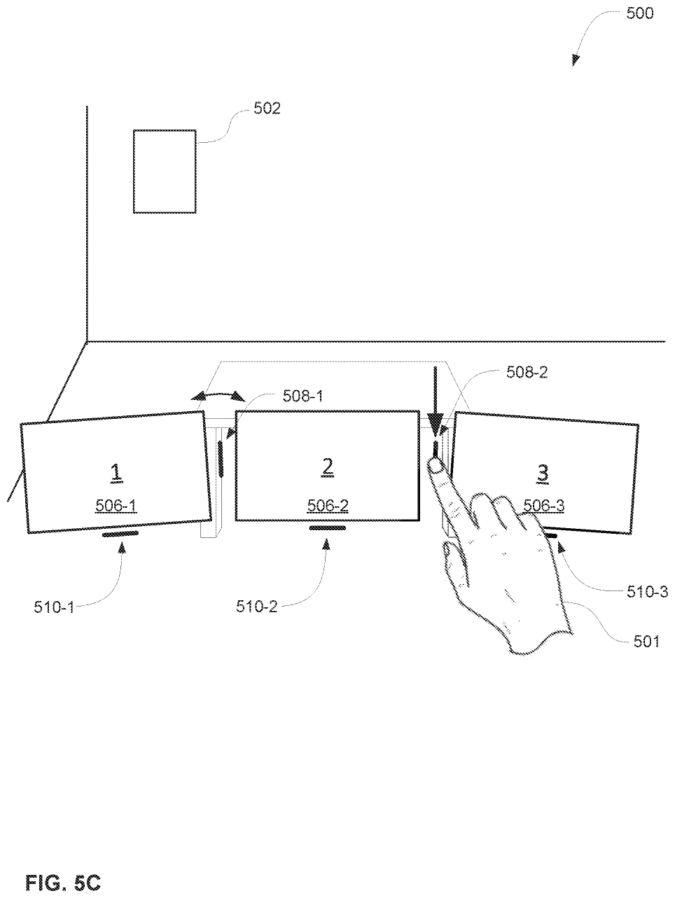

In some embodiments, affordance 408-1 and/or affordance 408-2 can be used for horizontal (e.g., x-axis), vertical (e.g., y-axis), and/or depth movements (e.g., z-axis). For example, in response to detecting a horizontal movement of hand 401 (e.g., while maintaining the selection gesture), affordance 408-2 (e.g., and thus, the user interfaces) moves horizontally in accordance with the horizontal movement of hand 401 (e.g., such as in FIGS. 4A-4B); in response to detecting a vertical movement of hand 401 (e.g., while maintaining the selection gesture), affordance 408-2 (e.g., and thus, the user interfaces) moves vertically in accordance with the vertical movement of hand 401 (e.g., as will be described in further detail below with respect to FIGS. 5A-5C); and in response to detecting a change in the depth of hand 401 (e.g., change in distance of hand 401 from user 414), affordance 408-2 (e.g., and thus, the user interfaces) changes depth in accordance with the change in depth of hand 401 (e.g., as will be described in further detail below with respect to FIGS. 6A-6B).

In some embodiments, the movement of affordance 408-2 (e.g., and/or of the user interfaces in the container) locks into one axis of movement based on the initial movement of hand 401. For example, if the initial threshold amount of movement of hand 401 (e.g., first inch of movement, first 3 inches of movement, first 6 inches of movement, first 0.25 seconds of movement, first 0.5 seconds of movement, first 1 second of movement, etc.) has a primary movement along a respective axis (e.g., the magnitude of movement in the respective axis is greater than the magnitude of movement in other axes), then after the initial threshold amount of movement of hand 401, affordance 408-2 locks to the respective axis (e.g., movement components along the other axes are ignored and/or do not cause movement in the corresponding axes).

In some embodiments, the movement of affordance 408-2 (e.g., and/or of the user interfaces in the container) does not lock into a respective axis and affordance 408-2 is able to move along any axis in accordance with the respective movement components of hand 401 (e.g., six degrees of freedom).

FIGS. 5A-5C illustrate a method of moving user interfaces in a container according to some embodiments of the disclosure. FIG. 5A illustrates first perspective of a three-dimensional environment 500 that includes elements similar to those described above with respect to FIG. 3 and FIGS. 4A-4B, the details of which are not repeated here.

In FIG. 5A, the device detects hand 501 performing a selection gesture on affordance 508-2. The selection gesture can be any of the selection gestures described above with respect to FIG. 4A. In FIG. 5B, the device detects that hand 501 has moved vertically upwards in the real world environment (e.g., upwards from its position in FIG. 5A) while maintaining the selection input that is selecting affordance 508-2 (e.g., while maintaining the forward pointing gesture, while maintaining the pinch gesture, etc.). In some embodiments, in response to detecting the upward movement of hand 501, affordance 508-2 and user interfaces 506-1, 506-2, and 506-3 move upwards in accordance with the movement of hand 501 (e.g., optionally while and/or concurrently with the movement of hand 501), as shown in FIG. 5B. For example, if hand 501 moved upwards by 6 inches, then user interfaces 506-1, 506-2, and 506-3 moved upwards by 6 inches (e.g., optionally if the interaction is a direct manipulation interaction). In some embodiments, the amount that affordance 508-2 and/or user interfaces 506-1, 506-2, and 506-3 are moved is a scaled amount of the amount that hand 501 moved (e.g., scaled by a factor of 2, 3, 4, ½, etc.), for example, if the interaction is an indirect manipulation interaction. In some embodiments, when user interfaces 506-1, 506-2, and 506-3 are a part of a container and are positioned on the surface of a sphere around the user, the amount that affordance 508-2 and/or user interfaces 506-1, 506-2, and 506-3 are moved is based on an angular displacement of hand 501 relative to the user. For example, if hand 501 moved upwards by 10 degrees relative to the user's forward facing vector, then affordance 508-2 and user interfaces 506-1, 506-2, and 506-3 can move along the surface of the sphere by 15 degrees upward (e.g., scaled by a factor of 1.5). Thus, in some embodiments, the movement of hand 501 causes affordance 508-2 to move with the movement of hand 501 (e.g., affordance 508-2 moves with the movement of hand 501 to stay at the same position relative to the position of hand 501) and causes the user interfaces in the container to move accordingly.

As shown in FIG. 5B, when the user interfaces moved vertically (e.g., upwards and/or downwards), the user interfaces appear to hinge (e.g., lean inwards or outwards). In some embodiments, as will be described in further detail below, the user interfaces appear to hinge because the user interfaces move upwards to a higher latitude on the surface of the sphere around the user. In some embodiments, the spacing between the user interfaces change such that certain portions of a user interface are closer to an adjacent user interface while other portions of the user interfaces are farther away from the adjacent user interface (e.g., due to leaning towards an adjacent user interface or leaning away from an adjacent user interface). For example, in FIG. 5B, user interface 506-3 and user interface 506-1 leaned inwards (e.g., towards the center of the container, towards user interface 506-2, which is the user interface at the center of the container, towards the location in the container that the user is facing, etc.) such that the top of the user interfaces are closer to the next adjacent user interface than before the user interfaces were moved upwards (e.g., optionally only the top of the user interfaces are closer, and the bottom of the user interfaces stay the same distance, for example, if the bottom corner of the user interfaces are the pivot for the rotation), the bottom of the user interfaces are farther away from the next adjacent user interface than before the user interfaces were moved upwards (e.g., optionally only the bottom of the user interfaces, and the top of the user interfaces stay the same distance, for example, if the top corner of the user interfaces are the pivot for the rotation), or both the top of the user interfaces are closer to the next adjacent user interface and the bottom of the user interfaces are farther away from the next adjacent user interface than before the user interfaces were moved upwards (e.g., the pivot for the rotation is a location between the top and bottom of the user interfaces, such as the center). In some embodiments, the average distance between the user interface is the same as before the user interfaces were moved upwards. In some embodiments, the average distance between the user is more or less than before the user interfaces were moved upwards.

Thus, as shown in FIG. 5B, in response to the user input, user interfaces 506-1 and 506-3 rotate in the roll dimension (e.g., rotating about the z axis, rotating clockwise or counter-clockwise, such that the top and bottom parts of the user interface move in the x-axis (e.g., horizontal position), optionally without moving in the y-axis (e.g., vertical position) or z-axis (e.g., depth)). In some embodiments, the change in the orientation of a respective user interface is based on the amount of vertical movement and/or the distance of the user interface from the user (e.g., how much the user interface moves along the surface of the sphere around the user and/or the radius of the sphere).

For example, if affordance 508-2 is moved upwards by a first amount, user interface 506-3 moves upwards by the first amount and appears to rotate counter-clockwise by a first respective amount, but if affordance 508-2 is moved upwards by a second, larger amount, user interface 506-3 moves upwards by the second, larger amount and appears to rotate counter-clockwise by a second respective amount that is larger than the first respective amount. Similarly, if user interfaces 506-1, 506-2, and 506-3 are a first distance away from the user, then in response to moving affordance 508-2 upwards by a first amount, user interface 506-3 moves upwards by the first amount and appears to rotate counter-clockwise by a first respective amount, but if the user interface 506-1, 506-2, and 506-3 are a second, farther, distance away from the user, then in response to moving affordance 508-2 upwards by the first amount (e.g., by the same amount), then user interface 506-3 moves upwards by the first amount and appears to rotate counter-clockwise by a second respective amount that is less than the first respective amount. Thus, the amount that a respective user interfaces rotates is based on its movement along the surface of a sphere that surrounds the user and the radius of the sphere.

Similarly to described above with respect to FIGS. 4A-4B, the user interfaces move along the surface of a sphere that surrounds the user (e.g., such as sphere 315 described above with respect to FIG. 3). In some embodiments, the user interfaces are located at the same vertical position (e.g., at the same latitude of the sphere) and as the user interfaces move upwards (e.g., in the +y direction), the user interfaces move to higher latitudes on the sphere. In some embodiments, at higher latitudes, the radius of the sphere is smaller (e.g., as compared to at the equator of the sphere) and thus, the curvature of the user interfaces around the user becomes higher. For example, the radius of the circle (e.g., the circle that is parallel to the equator) is smaller at latitudes above and below the equator of the sphere, and thus the user interfaces that are placed along the sphere curve around the user at a faster rate (e.g., at a smaller radius).

As a result of maintaining the spacing between the user interfaces, when moving the user interfaces to a latitude with a smaller radius, the user interfaces move to a different angular position along the sphere around the user. For example, if the user interfaces move to a higher latitude such that the radius of the sphere only supports four user interfaces while maintaining a constant distance between user interfaces, then the user interfaces are placed in front, to the left, to the right, and behind the user. Thus, if user interfaces 506-1 to 506-3 were originally placed at a −5 degree position (e.g., slightly to the left of directly in front of the user), at a 0 degree position (e.g., directly in front of the user) and at a +5 degree position (e.g., slightly to the right of directly in front of the user), respectively, then moving to a higher latitude can cause the user interfaces to be re-positioned to being at a −90 degree position (e.g., directly to the left of the user), 0 degree position (e.g., directly in front of the user), and at a +90 degree position (e.g., directly to the right of the user). In some embodiments, because the user interfaces move to a different angular position around the sphere, the user interfaces may appear to the user as if they are tilting, hinging, and/or leaning inwards towards the 0 degree position.

As an illustrative example, assume that the equator of a sphere around the user has a given radius that is capable of supporting eight user interfaces with six inches of separation between each user interface (e.g., assuming the eight user interfaces have the same width). In such an example, if the container includes three user interfaces placed along the equator of the sphere, then the three user interfaces can be placed at a −45 degree, 0 degree, and +45 degree angular position (e.g., the available positions are 0 degrees, +45 degrees, +90 degrees, +135 degrees, +180 degrees, −135 degrees, −90 degrees, and −45 degrees). If, in this example, the container is moved vertically, then the user interfaces may be moved to a latitude of the sphere that only supports four user interface (e.g., the radius of the sphere at that latitude is such that there is only space for the width of four user interfaces, including the six inches of separation between each user interface). In response, the electronic device redistributes the user interfaces around the sphere to maintain the six inches of separation. Thus, the available positions at this latitude are 0 degrees, +90 degrees, 180 degrees, and −90 degrees). As a result, the user interface that was previously placed at the −45 degree position is moved to the −90 degree position, the user interface that was previously placed at the +45 degree position is moved to the +90 degree position, and the user interface that was previously placed at the 0 degree position remains at the 0 degree position.

In some embodiments, the user interface that is directly in front of the user optionally is also moved to a new angular position. For example, the reference position (e.g., the “center location” where user interfaces do not experience a change in angular position) can be a location other than directly in front of the user. In such embodiments, user interfaces that are not located at the reference position can be moved. For example, the center user interface of the container (e.g., user interface 506-2), the user interface located closest to the center of the container (e.g., when the container includes user interfaces having varying widths), or other reference user interface can have its angular position maintained while user interfaces to the left or right of that reference user interface can be moved to a different angular position.

In some embodiments, although the user interfaces are placed along the sphere at a latitude with a smaller radius, the spacing between the user interfaces remain constant. As a result of maintaining the spacing between the user interfaces, when moving the user interfaces to a latitude with a smaller radius, in some embodiments, user interfaces to the left and right of directly in front of the user, such as user interfaces 506-1 and 506-3, respectively, in FIG. 5B, move to a different angular position along the surface of the sphere. For example, if user interfaces 506-1 to 506-3 were originally placed at a −5 degree position (e.g., slightly to the left of directly in front of the user), at a 0 degree position (e.g., directly in front of the user) and at a +5 degree position (e.g., slightly to the right of directly in front of the user), respectively, then moving to a higher latitude while maintaining a constant spacing between the user interfaces can cause the user interfaces to be re-positioned to being at a −90 degree position (e.g., directly to the left of the user), 0 degree position (e.g., directly in front of the user), and at a +90 degree position (e.g., directly to the right of the user).

In some embodiments, while the user interfaces move to new angular positions along the sphere around the user, the user interfaces optionally remain parallel to the floor. For example, the bottom edge of each user interface remains parallel to the floor and the top edge of each user interface remains parallel to the floor. In some embodiments, because each user interface remains parallel to the floor, but are at a latitude above the equator, the top of each user interface is closer to the next adjacent user interface as compared to the bottoms of each user interface. For example, the top of each user interface is at a higher latitude than the bottom of each user interface and as a result, at a position with a smaller radius. The smaller radius causes the tops of the user interfaces to be closer to each other than the bottom of the user interfaces, which have a larger radius.

Thus, the user interfaces optionally are not actually rotated clockwise or counter-clockwise (e.g., in the roll orientation) in three-dimensional environment 500 (e.g., the user interface still remain parallel to the floor), even though the user interfaces appear, to the user, as if they are leaning towards or away from each other (e.g., as if they are no longer parallel to the floor). In some embodiments, this phenomenon can be at least partially a result of capturing three-dimensional environment 500 from a particular camera position and projecting the view of three-dimensional environment 500 onto a flat surface (e.g., an optical aberration, a radial distortion, barrel distortion, “fish-eye” effect, etc.).

As described above, the user interfaces are optionally always facing directly at the user. For example, the normal vector for each user interface is pointed at the user, regardless of where the user interface is located in three-dimensional environment 500. Thus, when the user interfaces move vertically upwards to a height above the user, the user interfaces additionally or alternatively begin tilting downwards (e.g., pitching downwards) in accordance with the upward movement, to maintain the normal angle pointed at the user (e.g., pointing downwards towards the user which is at a lower elevation than the user interfaces).

As described above, moving user interface 506-3 farther outwards causes user interface 506-3 to appear to the user as if it is leaning inwards (e.g., leaning counter-clockwise towards user interface 506-2). In some embodiments, if the user were to turn his or her body and/or head to face user interface 506-3, user interface 506-3 would appear to the user as parallel to the horizon instead of leaning inwards (e.g., and user interface 506-2 would now appear to be leaning clockwise towards user interface 506-3). In some embodiments, this phenomenon is a result of the change in the orientation of the view of three-dimensional environment 500, such that user interface 506-3 is now at the center of the display area and experiences less radial distortion than user interface 506-2, which is now to the left of the center of the display area and experiences more radial distortion.

Thus, while the user interfaces are located at a respective height with respect to the user (e.g., eye level, head level, body level, etc., which optionally corresponds to the equator of the sphere around the user), the user interfaces appear horizontally aligned (e.g., not tilted), but while the user interfaces are above or below the respective height (e.g., above or below the equator of the sphere around the user), the user interfaces move to new angular positions along the sphere and thus appear tilted inwards or outwards, respectively (as will be described in further detail below with respect to FIG. 5C).

For example, in FIG. 5A, the user interfaces are optionally at the height of the user and at the height of the widest radius of the sphere (e.g., the equator of the sphere). In FIG. 5B, the user interfaces have been moved upwards along the surface of the sphere around the user, to a portion on the sphere that has a circular radius smaller than the circular radius in FIG. 5A. In some embodiments, the user interfaces follow the contour of the sphere (e.g., the orientation of the user interfaces are based on the orientation of the portion of the sphere at which the user interfaces are located). As a result, the user interfaces that are not directly in front of the user (e.g., user interface 506-1, which is slightly to the left of directly in front of the user, and user interface 506-3, which is slightly to the right of directly in front of the user) move to new angular positions along the sphere (e.g., outwards along the sphere and/or away from user interface 506-2) and appear to lean inwards towards the user interface that is directly in front of the user (e.g., user interface 506-2). In some embodiments, the user interfaces remain oriented toward the user (e.g., due to the location of the sphere being the focal point of the sphere). Thus, if the user were to rotate to face toward user interface 506-3, such that user interface 506-3 is directly in front of the user, then user interface 506-3 optionally would not appear to be rotated (e.g., user interface 506-3 would optionally appear to be parallel to the floor) and user interface 506-2 would appear to be rotated counterclockwise inwards towards user interface 506-3 (e.g., in a manner similar to user interface 506-1 in FIG. 5B).

In some embodiments, because the user interfaces have moved to a new latitude along the sphere around the user and the curvature of the user interfaces is higher, the user interfaces optionally appear to be curved at a smaller radius around the user. For example, as user interfaces 506-1, 506-2, and 506-3 move upwards, user interface 506-1 optionally appear to begin to rotate (e.g., in the yaw orientation) to face further rightwards and user interface 506-3 optionally begins to rotate (e.g., in the yaw orientation) to face further leftwards as a result of the radius of the latitude on which the user interfaces are located becoming smaller and the movement of the respective user interfaces to new angular positions that are further outwards than their previous respective angular positions. In some embodiments, in addition to moving the user interfaces to a new angular position (e.g., thus causing the user interfaces to appear to rotate in the yaw direction), as the user interfaces move upwards, the user interfaces begin to rotate in the pitch direction. For example, the user interface begins to face downwards towards the user (e.g., due to being at a height above the user, but still maintaining an orientation that is pointed toward the user, as described above). In some embodiments, the rotation in the yaw and pitch orientations follow the same general principles as those described above.

In some embodiments, as described above, moving affordance 508-2 upwards causes the one or more user interfaces of the container to move upwards along the surface of a sphere around the user and move to a new angular position that is optionally farther outwards (e.g., from 1 degree to the left of the reference location, to 2 degrees to the left of the reference location, from 5 degrees to the left of the reference location, to 10 degrees to the left of the reference location, etc.), which optionally causes the user interfaces to appear to rotate in roll dimension (and optionally also in the yaw and/or pitch orientations). In some embodiments, while the user interfaces move upwards or downwards to different latitudes, the user interfaces remain the same distance away from the user as before the upward movement due to, for example, the user interfaces remaining on the surface of the sphere around the user, which does not change radius. Thus, in some embodiments a change in the y-axis (e.g., the user interfaces moving up and farther away from the user in the y-axis) is optionally offset by the change in the z-axis (e.g., the user interfaces moving forward in the three-dimensional environment and closer to the user).

In some embodiments, not every user interface appears to rotate and not every user interface appears to rotate by the same amount and/or in the same direction. For example, as shown in FIG. 5B, user interface 506-1 appears to rotate in a clockwise manner, user interface 506-2 did not appear to rotate, and user interface 506-3 appears to rotate in a counter-clockwise manner. In some embodiments, the user interface at the center of the container and/or the user interface that is directly in front of the user does not change angular position (e.g., due to being at the reference location and/or due to being the reference user interface) and thus, does not appear to tilted inwards or outwards, and the user interfaces to the left and/or right of the user interface that did not change angular positions are moved to new outward angular positions (e.g., thus causing them to appear to be tilted to lean towards the user interface that did not tilt inwards or outwards). In some embodiments, if the container includes an even number of containers (e.g., there is no user interface that is in the center of the container) and/or the user is facing a location between two user interfaces, then the reference location is optionally not co-located with any user interface and all user interfaces change angular positions (e.g., away from the reference location) and appear to tilt inwards or outwards (e.g., towards the reference location, which optionally is between the two user interfaces corresponding to the center of the container and/or where the user is facing).

In some embodiments, affordances 510-1, 510-2, and 510-3 move and/or appear to rotate in accordance with the movement of their respective associated user interfaces. For example, affordance 510-3 moves and/or appears to rotate in a manner such that affordance 510-3 remains parallel with user interface 506-3 and centered with user interface 506-3. In some embodiments, affordances 508-1 and 508-2 move and/or appears to rotate in accordance with the movement of the user interfaces. For example, affordance 508-1 moves such that it remains the same relative position between user interface 506-1 and user interface 506-2 (e.g., at the halfway point between user interface 506-1 and user interface 506-2) and appears to rotate to have an orientation that is based on the orientation of user interface 506-1 and user interface 506-2 (e.g., the average of the orientations of the two user interfaces).

FIG. 5C illustrates hand 501 moving vertically downwards in the real world environment (e.g., downwards from its position in FIG. 5A and/or FIG. 5B) while maintaining the selection input that is selecting affordance 508-2 (e.g., while maintaining the forward pointing gesture, while maintaining the pinch gesture, etc.). In some embodiments, in response to detecting the downward movement of hand 501, affordance 508-2 and user interfaces 506-1, 506-2, and 506-3 are moved downward in accordance with the movement of hand 501 (e.g., optionally while and/or concurrently with the movement of hand 501, in a manner similarly to described above with respect to FIG. 5B), as shown in FIG. 5C. Thus, in some embodiments, the movement of hand 501 causes affordance 508-2 to move downwards with the movement of the hand (e.g., affordance 508-2 moves with the movement of hand 501 to stay at the same position relative to the position of hand 501) and causes the user interfaces in the container to move accordingly. In some embodiments, affordance 508-2 and/or user interfaces 506-1, 506-2, and 506-3 move by a scaled amount of the movement of hand 501 (e.g., half as much, twice as much, etc., for example, if the interaction is an indirect manipulation operation).

As described above with respect to FIG. 5B and shown in FIG. 5C, moving affordance 508-2 downwards causes the user interfaces within the container that is associated with affordance 508-2 to move to a different angular position along the sphere (e.g., as a result of moving to a lower latitude, which has a smaller radius than at the equator, thus appearing to hinge and/or lean outwards). For example, in FIG. 5C, user interface 506-1 appears to lean outwards (e.g., leaned counter-clockwise to the left), user interface 506-2 did not change orientation (e.g., did not lean inwards or outwards), and user interface 506-3 appears to lean outwards (e.g., leaned clockwise to the right).

Thus, the user interfaces in the container appear to lean (e.g., tilted, rotated in the roll orientation) away from a center point of the container (e.g., the reference point for the change in angular position). In some embodiments, the reference point of the container is horizontally located at the middle of the total width of the container. In some embodiments, the reference point of the container is the location within the container that the user of the device is facing (e.g., the location that the user is gazing at, the location that the body of the user is facing, etc.). For example, in FIG. 5C, the user is facing user interface 506-2 (e.g., the user's head is facing user interface 506-2, the user's body is facing user interface 506-2, and/or the cameras of the device are facing towards the location in the physical environment associated with user interface 506-2), and thus user interface 506-2 is the reference point and as a result, user interface 506-2 remains in the same angular position. As a result, user interface 506-2 appears as if it is not rotated and/or tilted while the user interfaces to the left and right of user interface 506-2 are moved outwards in angular position, thus appearing to have rotated and/or tilted outwards (e.g., user interface 506-1 rotated counter-clockwise and user interface 506-1 rotated clockwise). In some embodiments, if the user is facing user interface 506-3 when the downward movement of hand 501 is received, then user interface 506-3 is the reference location and does not change in angular position (e.g., user interface 506-3 does not appear to tilt and/or lean while user interfaces 506-1 and 506-2 tilt and/or rotate counter-clockwise to the left).

As described above with respect to FIG. 5B, because the vertical position of user interfaces 506-1, 506-2, and 506-3 is moved to a latitude below the equator of the sphere surrounding the user, user interfaces 506-1, 506-2, and 506-3 optionally rotate in the roll, yaw, and/or pitch orientations. For example, moving to a lower latitude optionally causes the curvature of the user interfaces to become higher (e.g., as a result of being at a location with a smaller radius) and thus the user interfaces rotate in the yaw orientation (e.g., rotate to face further toward the center of the container and/or the location of the user). Similarly, moving to a lower latitude optionally causes the user interfaces to rotate in the pitch direction to face upwards towards the user (e.g., due to being at a lower elevation than the user's face, the user's eyes, the user's gaze, etc.).

Thus, moving the container to a lower latitude causes the user interfaces to change angular position, and as a result, the user interfaces appear to lean outwards and moving the container to a higher latitude causes the user interfaces to also change in angular position, in much the same way as moving to a lower latitude, and as a result, the user interfaces appear to lean inwards. In some embodiments, this phenomenon is at least partially due to the curvature of the sphere around the user and/or at least partially due to artifacts resulting from displaying a three-dimensional scene on a two-dimensional surface (e.g., such as a display screen, etc.). In some embodiments, moving the containers to a latitude higher or lower than the equator of the sphere optionally causes the user interfaces to rotate in the pitch and yaw orientations in the manner described above with respect to FIG. 5B.

FIGS. 6A-6B illustrate a method of moving user interfaces in a container according to some embodiments of the disclosure. FIG. 6A illustrates first perspective 600 and second perspective 612 of a three-dimensional environment that includes elements similar to those described above with respect to FIG. 3, FIGS. 4A-4B, and FIGS. 5A-5C, the details of which are not repeated here.

In FIG. 6A, the device detects hand 601 performing a selection gesture on affordance 608-2. The selection gesture can be any of the selection gestures described above with respect to FIG. 4A. In FIG. 6B, the device detects that hand 601 has moved forward in the real world environment (e.g., in the +z direction, farther from the user, etc.) while maintaining the selection input that is selecting affordance 508-2 (e.g., while maintaining the forward pointing gesture, while maintaining the pinch gesture, etc.). In some embodiments, in response to detecting the forward movement of hand 601, affordance 608-2 and user interfaces 606-1, 606-2, and 606-3 move forward in the three-dimensional environment (e.g., away from the user, in the +z direction) in accordance with the movement of hand 601 (e.g., optionally while and/or concurrently with the movement of hand 601), as shown in FIG. 6B. For example, if hand 601 moved forward by 6 inches, then user interfaces 606-1, 606-2, and 606-3 moved forward by 6 inches (e.g., optionally if the interaction is a direct manipulation interaction). In some embodiments, the amount that affordance 608-2 and/or user interfaces 606-1, 606-2, and 606-3 are moved is a scaled amount of the amount that hand 601 moved (e.g., scaled by a factor of 2, 3, 4, ½, etc.), for example, if the interaction is an indirect manipulation interaction. Thus, in some embodiments, the movement of hand 601 causes affordance 608-2 to move with the movement of hand 601 (e.g., affordance 608-2 moves with the movement of hand 601 to stay at the same position relative to the position of hand 601) and causes the user interfaces in the container to move accordingly.

As shown in FIG. 6B, user interfaces 606-1, 606-2, and 606-3 move forward in the z direction by the same amount such that user interfaces 606-1, 606-2, and 606-3 remain equidistant to user 614. In some embodiments, because user interfaces 606-1, 606-2, and 606-3 are constrained to be located on the surface of sphere 615, in order for user interfaces 606-1, 606-2, and 606-3 to move in the z-direction, sphere 615 optionally changes size based on the movement of hand 601. For example, as shown in FIG. 6B, the radius of sphere 615 increases accordingly such that the user interfaces that are located on the surface of sphere 615 are able to move to the requested location in the three-dimensional environment while remaining on the surface of sphere 615. In some embodiments, a similar behavior is exhibited in response to the movement of hand 601 inwards.

For example, in response to detecting an inward movement of hand 601, affordance 608-2 and/or user interfaces 606-1, 606-2, and 606-3 move inwards in accordance with the movement of hand 601 and the radius of sphere 615 decreases accordingly.

In some embodiments, because the radius of sphere 615 changed in response to the outward and/or inward movement of hand 601, the curvature of the user interfaces around the user can change accordingly. For example, if user interface 606-3 were six degrees to the right of directly ahead before the forward movement, then if the user interfaces are moved twice as far away, thus increasing the radius of sphere 615 to twice the size, then user interface 606-3 is optionally now located three degrees to the right of directly ahead of the user. In some embodiments, changing the angular position of user interface 606-3 causes user interface 606-3 to appear as if it is maintaining the same distance from user interface 606-2 as before the forward movement. For example, if user interface 606-3 were to move outwards while maintaining the same angular position on sphere 615, then user interface 606-3 would move farther away from user interface 606-2 (e.g., due to the rays pointed from the center of sphere 615 to each user interface diverging in order to maintain the same angle).

In some embodiments, because one or more of the user interfaces in the container changed angular position on the surface of sphere 615, the orientation of the respective user interface optionally changes (e.g., in the yaw orientation) in accordance with the angle of the new location on the surface of sphere 615. For example, the orientation for user interface 606-1 and user interface 606-3 optionally becomes shallower (e.g., rotated to face more forward in the −z direction than before and less inwards in the y direction than before). In some embodiments, not every user interface changes orientation. For example, in FIG. 6B, user interface 606-1 and user interface 606-3 optionally rotates in the yaw orientation but user interface 606-2 does not rotate in the yaw direction (e.g., the orientation of user interface 606-2 is already facing directly forward, so it cannot be rotated shallower).

In some embodiments, additionally or alternatively to changing the orientation of the user interfaces in the container, in response to moving user interfaces 606-1, 606-2, and 606-3 farther away from user 614 (e.g., in the z direction), the size of user interfaces 606-1, 606-2, and 606-3 are changed based on the amount of movement in the z direction. In some embodiments, the size of user interfaces 606-1, 606-2, and 606-3 can be scaled to offset the change in depth. For example, if user interfaces 606-1, 606-2, and 606-3 are moved to be twice as far away from the user, without changing the size of user interfaces 606-1, 606-2, and 606-3, the user interfaces would appear to be half their original size (e.g., due to the perspective effect). Thus, in some embodiments, if the user interfaces are moved to be twice as far away from user 614, the size of user interfaces 606-1, 606-2, and 606-3 can be doubled (e.g., while maintaining the same aspect ratio) such that the user interfaces appear to the user to be the same size as before they were moved farther away (e.g., the size of the user interface changes to compensate for the perceived change in size due to the perspective effect). However, the user would optionally be able to perceive that user interfaces 606-1, 606-2, and 606-3 are now no longer in front of table 604 (e.g., as shown by second perspective 612).

Thus, as described above, in some embodiments, in response to manipulating an affordance associated with a user interface and/or a container, one or more user interfaces that are members of the same container optionally move in accordance with the manipulation. In some embodiments, user interfaces that are not members of the same container optionally do not move in accordance with a manipulation of one of the user interfaces or manipulation of a container. For example, if the three-dimensional environment includes a first container with a first and second user interface and a second container with a third and fourth user interface, and a fifth user interface that is not part of any containers, then in response to a manipulation of a user interface in the first container, the other user interface in the first container is also manipulated in a similar way (e.g., the first container is manipulated), but the third, fourth, and fifth user interfaces are not manipulated; in response to manipulation of a user interface in the second container, the other user interface in the second container is also manipulated in a similar way (e.g., the second container is manipulated), but the first, second, and fifth user interfaces are not manipulated; and in response to manipulation of the fifth user interface, the first, second, third, and fourth interfaces are not manipulated.

In some embodiments, when user interfaces are members of a container, then in response to a manipulation of the user interfaces, one or more orientations of the user interfaces may automatically change based on the type of manipulation. For example, if the user interfaces are moved horizontally (e.g., horizontally translated, along the x axis), then the user interfaces optionally move horizontally in a circular fashion around the user and/or the user interfaces rotate in the yaw orientation (e.g., about the y axis) (optionally without rotating in the roll or pitch orientations). On the other hand, if the user interfaces are moved vertically (e.g., vertically translated, along the y axis), then the user interfaces optionally move vertically in a circular fashion around the user, change angular positions, and/or rotate or appear to rotate in one or more of the roll orientation (e.g., lean inwards or outwards, about the z axis), the yaw orientation (e.g., about the y axis), and the pitch orientation (e.g., downwards or upwards, about the x axis). Lastly, if the user interfaces are moved closer or farther away from the user (e.g., along the z axis), then the user interfaces optionally change size based on the movement in the z direction and optionally rotates in the yaw orientation (e.g., about the y axis) (e.g., optionally without rotating in the roll or pitch orientations).

It is understood that the user interfaces and/or containers can move in multiple dimensions concurrently and are not limited to movement in only one dimension at a time. In some embodiments, if the user interfaces are translated in multiple dimensions, then the translations can be dissected into horizontal translation components, vertical translation components and/or depth translation components and the user interfaces can then be manipulated based on a combination of responses to the horizontal component of the translation, the vertical component of the translation, and/or the depth component of the translation.

In some embodiments, the affordances displayed between the user interfaces in a container (e.g., such as affordances 308-1 and 308-2) are manipulable to move the user interfaces in the container (e.g., move the container) in the horizontal (e.g., as described above in FIGS. 4A-4B), vertical (e.g., as described above in FIGS. 5A-5C), and z directions (e.g., as described above in FIGS. 6A-6B). It is understood that although interactions with affordances 408-2, 508-2, and 608-2, respectively, are illustrated in FIGS. 4A-4B, 5A-5C, and 6A-6B, respectively, that similar behavior can be implemented using interactions with other affordances (e.g., 408-1, 508-1, and 608-1, respectively). In some embodiments, the affordances displayed below the user interfaces (e.g., such as affordances 310-1, 310-2, and 310-3) are manipulable to move the respective user interface without moving the other user interfaces in the same container. For example, in FIG. 3, in response to a user selecting and moving affordance 310-3, if the movement of affordance 310-3 is more than a threshold amount (e.g., more than 1 inch, more than 2 inches, more than 6 inches, etc.), then user interface 310-3 is removed from the container that includes user interfaces 310-1 and 310-2. For example, in response to moving affordance 310-3 more than the threshold amount, user interface 310-3 is no longer a member of a container and is able to be moved freely (e.g., in the x, y, and z directions, without being constrained to the surface of sphere 315) in response to moving affordance 310-3, without moving user interface 306-1 and user interface 306-2.

Alternatively to the embodiment described above, in some embodiments, the affordances displayed between the user interfaces in a container (e.g., such as affordances 308-1 and 308-2) can be used to perform some manipulations and not other manipulations, while the affordances displayed below the user interfaces (e.g., such as affordances 310-1, 310-2, and 310-3) can be used to perform the other manipulations, but not the manipulations that are performable with the affordances between the user interfaces in a container. For example, in some embodiments, affordances 308-1 and 308-2 can be used to perform horizontal manipulations (e.g., such as in FIGS. 4A-4B), but cannot be used to perform vertical manipulations (e.g., such as in FIG. 5A-5C) or depth manipulations (e.g., such as in FIGS. 6A-6B). In such embodiments, affordances 310-1, 310-2, and 310-3 can be manipulated to perform vertical manipulations and depth manipulations of the user interfaces of the user interfaces in the container.

Alternatively to the embodiment described above, in some embodiments, the affordances displayed below the user interfaces (e.g., such as affordances 310-1, 310-2, and 310-3) can be used to perform horizontal (e.g., as described above in FIGS. 4A-4B), vertical (e.g., as described above in FIGS. 5A-5C), and depth manipulations of the user interfaces in the container (e.g., as described above in FIGS. 6A-6B). In such embodiments, the affordances displayed between the user interfaces in a container (e.g., such as affordances 308-1 and 308-2) cannot be used to perform horizontal, vertical, or depth manipulations of the user interfaces in the container and are optionally used for detaching one or more user interfaces from the container (e.g., removing respective user interfaces from the container).

Alternatively to the embodiment described above, in some embodiments, both the affordances displayed between the user interfaces in a container (e.g., such as affordances 308-1 and 308-2) and the affordances displayed below the user interfaces (e.g., such as affordances 310-1, 310-2, and 310-3) can be manipulated to perform horizontal (e.g., as described above in FIGS. 4A-4B), vertical (e.g., as described above in FIGS. 5A-5C), and depth manipulations of the user interfaces in the container (e.g., as described above in FIGS. 6A-6B).

In some embodiments, additionally or alternatively to the embodiments described above, the affordances displayed between the user interfaces in a container (e.g., such as affordances 308-1 and 308-2) can be actuated to detach one or more user interfaces from the container (e.g., removing respective user interfaces from the container). For example, instead of performing a selection input and holding the selection input while moving (e.g., as in the embodiments described above with respect to FIGS. 4A-6B above), if a user performs a click input (e.g., a selection input followed by a release of the selection input within a threshold amount of time, a pinch for less than a threshold duration, a poke with a finger for less than a threshold duration), then in response to the click input, one or more of the user interfaces adjacent to the selected affordance is detached from the container and is no longer a member of the container, while the other user interfaces remain members of the container.

It is understood that although the figures illustrate user interfaces in a container aligned horizontally, user interfaces in a container can be arranged in any orientation. For example, user interfaces can be oriented vertically, horizontally, or in a grid (e.g., 2×2 grid, 3×3 grid, 2×4 grid, etc.). In such embodiments, user interfaces can be added or inserted anywhere within the container (e.g., above, below, to the left or right, etc.).

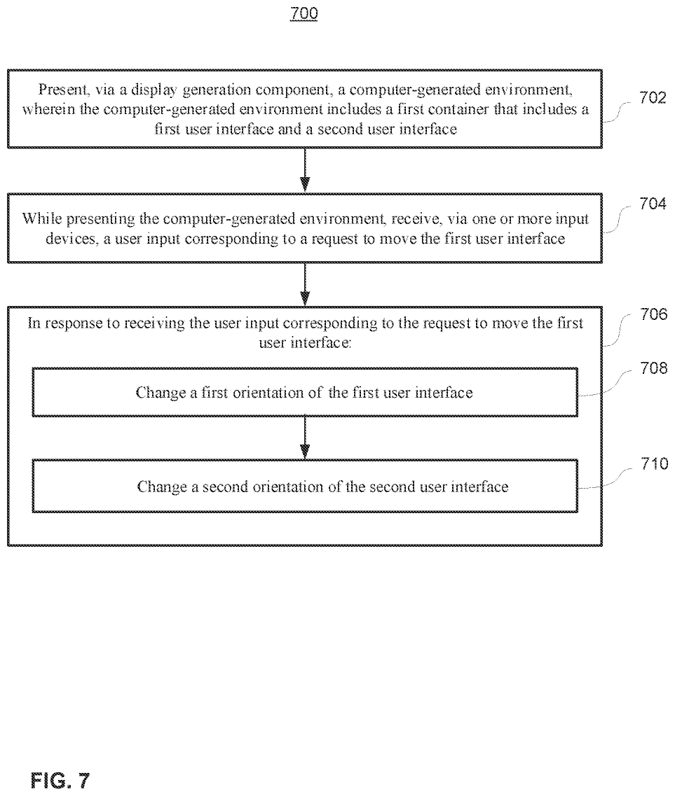

FIG. 7 is a flow diagram illustrating a method 700 of moving user interfaces in a container in a three-dimensional environment according to some embodiments of the disclosure. The method 700 is optionally performed at an electronic device such as device 100 and device 200, when moving user interfaces in a container described above with reference to FIGS. 3, 4A-4B, 5A-5B, and 6A-6B. Some operations in method 700 are, optionally combined (e.g., with each other) and/or order of some operations is, optionally, changed. As described below, the method 700 provides methods of moving user interfaces in a container in a three-dimensional environment in accordance with embodiments of the disclosure (e.g., as discussed above with respect to FIGS. 3-6B).

In some embodiments, an electronic device (e.g., a mobile device (e.g., a tablet, a smartphone, a media player, or a wearable device), a computer, etc. such as device 100 and/or device 200) in communication with a display generation component (e.g., a display integrated with the electronic device (optionally a touch screen display) and/or an external display such as a monitor, projector, television, etc.) and one or more input devices (e.g., a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera (e.g., visible light camera), a depth sensor and/or a motion sensor (e.g., a hand tracking sensor, a hand motion sensor), etc.) presents (702), via the display generation component, a computer-generated environment, wherein the computer-generated environment includes a first container that includes a first user interface and a second user interface, such as user interface 306-1 and user interface 306-2 in FIG. 3.

In some embodiments, while presenting the computer-generated environment, the electronic device receives (704), via the one or more input devices, a user input corresponding to a request to move the first user interface, such as detecting a selection of affordance 408-2 by hand 401 and a movement of hand 401 while maintaining the selection in FIGS. 4A-4B.

In some embodiments, in response to receiving the user input corresponding to the request to move the first user interface (706), the electronic device changes (708) a first orientation of the first user interface, and changes (710) a second orientation of the second user interface, such as changing the orientation of user interface 406-1 and changing the orientation of user interface 406-2, such as to move the respective user interfaces along the surface curvature of sphere 415 in FIG. 4B.

In some embodiments, in response to receiving the user input corresponding to the request to move the first user interface, the electronic device moves the first user interface in accordance with the user input, and moves the second user interface in accordance with the user input, such as moving user interface 406-1 and user interface 406-2 rightwards in accordance with the rightward movement of hand 401 in FIG. 4B.

In some embodiments, in accordance with a determination that the request to move the first user interface includes a request to move the first user interface in a first direction, moving the first user interface includes changing a size of the first user interface, and moving the second user interface includes changing a size of the second user interface, such as increasing the size of user interface 406-1 and user interface 406-2 when moving the user interfaces farther away from the user (e.g., in the z direction) in FIG. 6B.

In some embodiments, in accordance with a determination that the request to move the first user interface includes a request to move the first user interface in a second direction, different from the first direction, moving the first user interface includes moving the first user interface without changing a size of the first user interface and moving the second user interface includes moving the second user interface without changing a size of the second user interface, such as not changing the size of user interface 406-1 and user interface 406-2 when moving the user interfaces in the x or y directions in FIG. 4B and FIGS. 5B-5C.

In some embodiments, before receiving the request to move the first user interface in the first direction, the first user interface is a first distance from a user of the device, and the second user interface is a first distance from the user, such as in FIG. 6A. In some embodiments, the request to move the first user interface in the first direction includes a request to change a depth of the first user interface from being the first distance from the user to being a second distance from the user, such as hand 601 moving forwards (e.g., away from the user) in FIG. 6B. In some embodiments, in accordance with the determination that the request to move the first user interface includes the request to move the first user interface in the first direction, the electronic device moves the first user interface from being the first distance from the user to being the second distance from the user, and moves the second user interface from being the first distance from the user to being the second distance from the user, such as the movement of user interfaces 606-1, 606-2, and 606-3 farther in the z direction in FIG. 6B.

In some embodiments, in accordance with the determination that the request to move the first user interface includes the request to move the first user interface in the second direction, the electronic device moves the first user interface in the second direction without changing a distance from a user of the device and moves the second user interface in the second direction without changing a distance from the user, such as in user interfaces 406-1, 406-2, and 406-3 maintaining the same distance from the user when moving horizontally in FIG. 4B, and user interfaces 506-1, 506-2, and 506-3 maintaining the same distance from the user when moving vertically in FIG. 5B.

In some embodiments, changing a first orientation of the first user interface includes, in accordance with a determination that the request to move the first user interface includes a request to move the first user interface in a first direction, rotating the first user interface in a first orientation, such rotating user interface 406-1 in the yaw direction in FIG. 4B.

In some embodiments, in accordance with a determination that the request to move the first user interface includes a request to move the first user interface in a second direction, different from the first direction, rotating the first user interface in a second orientation, different from the first orientation, such as rotating user interface 406-1 in the roll direction in FIG. 5B.

In some embodiments, in response to receiving the user input corresponding to the request to move the first user interface, in accordance with the determination that the request to move the first user interface includes the request to move the first user interface in the first direction, the electronic device maintains a distance between the first user interface and the second user interface, such as maintaining the spacing between user interfaces 406-1, 406-2, and 406-3 while the user interfaces are being moved in FIG. 4B.

In some embodiments, in accordance with the determination that the request to move the first user interface includes the request to move the first user interface in a second direction, changing a distance between a first part of the first user interface and a corresponding part of the second user interface, such as leaning user interfaces 506-1 and 506-3 such that portions of the spacing between user interfaces 506-1, 506-2, and 506-3 change (e.g., the spacing for certain portions get smaller and the spacing for other portions get larger) in FIGS. 5B-5C.

In some embodiments, the request to move the first user interface in the first direction includes a request to move the first user interface horizontally in the computer-generated environment, such as in FIGS. 4A-4B. In some embodiments, rotating the first user interface in the first orientation includes rotating the first user interface in a yaw orientation, such as user interfaces 406-1, 406-2, and 406-3 rotating in a yaw orientation such as to curve around user 414 in FIG. 4B.

In some embodiments, the request to move the first user interface in the second direction includes a request to move the first user interface vertically in the computer-generated environment, such as in FIGS. 5A-5C. In some embodiments, rotating the first user interface in the second orientation includes rotating the first user interface in a pitch orientation, such as user interfaces 506-1, 506-2, and 506-3 rotating in the pitch direction to pitch downwards towards the user in FIG. 5B, and upwards towards the user in FIG. 5C.

In some embodiments, receiving the user input corresponding to the request to move the first user interface includes detecting a selection gesture from a hand of the user directed at a movement affordance and a movement of the hand of the user while maintaining the selection gesture, such as in FIGS. 4A-4B.

In some embodiments, the computer-generated environment includes one or more movement affordances of a first type and one or more movement affordances of a second type, such as affordances 308-1 and 308-2, and affordances 310-1, 310-2, and 310-3 in FIG. 3. In some embodiments, the one or more movement affordances of the first type are interactable to perform a first type of manipulation on the first user interface and the second user interface, such as to affordances 408-1 and 408-2 being interactable to move user interfaces 406-1, 406-2, and 406-3 horizontally in FIGS. 4A-4B. In some embodiments, the one or more movement affordances of the second type are interactable to perform a second type of manipulation on the first user interface and the second user interface, such as if affordances 410-1, 410-2, and 410-2 were interactable to move user interfaces 406-1, 406-2, and 406-3 vertically.

In some embodiments, the computer-generated environment includes one or more movement affordances of a first type and one or more movement affordances of a second type, such as affordances 308-1 and 308-2, and affordances 310-1, 310-2, and 310-3 in FIG. 3. In some embodiments, the one or more movement affordances of the first type are interactable to perform a first type of manipulation and a second type of manipulation on the first user interface and the second user interface, such as affordances 408-1 and 408-2 being interactable to move user interfaces 406-1, 406-2, and 406-3 horizontally in FIGS. 4A-4B, and vertically in FIGS. 5A-5C. In some embodiments, the one or more movement affordances of the second type are interactable to manipulate a given user interface of the first user interface and second user interface, without manipulating an other user interface of the first user interface and second user interface, such as if affordances 410-1, 410-2, and 410-3 were interactable to move only their respective user interfaces separately from the other user interfaces in the container (e.g., optionally removing the respective user interface from the container).

In some embodiments, the first type of manipulation includes a movement in a first direction, such as in the horizontal direction in FIGS. 4A-4B. In some embodiments, the second type of manipulation includes a movement in a second direction, different from the first direction, such as in the vertical direction in FIGS. 5A-5C.

In some embodiments, before receiving the user input corresponding to the request to move the first user interface, the first user interface has a first distance from a user of the device and the second user interface has the first distance from the user, such as in FIG. 4A. In some embodiments, after receiving the user input corresponding to the request to move the first user interface, the first user interface has a second distance from a user of the device and the second user interface has the second distance from the user, such as in FIG. 4B. In some embodiments, the first distance and the second distance are a same distance. For example, in FIG. 4B, after moving horizontally, user interfaces 406-1, 406-2, and 406-3 all have the same distance from the user (e.g., which didn't change). Similarly, in FIG. 6B, after moving farther away from the user, user interfaces 406-1, 406-2, and 406-3 all have the same distance from the user (e.g., which changed).

In some embodiments, a normal vector of the first user interface is directed at a location in the computer-generated environment corresponding to a user of the device. In some embodiments, a normal vector of the second user interface is directed at the location in the computer-generated environment corresponding to the user. For example, in FIG. 4A, the normal vector of user interfaces 406-1, 406-2, and 406-3 all pointed at the user in FIG. 4A.

In some embodiments, after receiving the user input corresponding to the request to move the first user interface, a normal vector of the first user interface is directed at a location in the computer-generated environment corresponding to a user of the device, and a normal vector of the second user interface is directed at the location in the computer-generated environment corresponding to the user. For example, after moving horizontally in FIG. 4B, user interfaces 406-1, 406-2, and 406-3 all remain pointed at the user.

In some embodiments, the computer-generated environment includes a third user interface that is not a member of the first container. In some embodiments, in response to receiving the user input corresponding to the request to move the first user interface, forgo changing an orientation of the third user interface. For example, if the three-dimensional environment (e.g., first perspective 400) included a user interface that is not a part of a container that includes user interfaces 406-1, 406-2, and 406-3, then in response to request to move user interfaces 406-1, 406-2, and 406-3 horizontally, the user interface that is not part of the container does not move horizontally with the movement of 406-1, 406-2, and 406-3. In some embodiments, the user interface that is not part of the container remains in its original position. In some embodiments, user interfaces that are not a part of a container are not affected when a container is manipulated or when a user interface in a container is manipulated.

It should be understood that, as used herein, presenting an environment includes presenting a real-world environment, presenting a representation of a real-world environment (e.g., displaying via a display generation component), and/or presenting a virtual environment (e.g., displaying via a display generation component). Virtual content (e.g., user interfaces, content items, etc.) can also be presented with these environments (e.g., displayed via a display generation component). It is understood that as used herein the terms “presenting”/“presented” and “displaying”/“displayed” are often used interchangeably, but depending on the context it is understood that when a real world environment is visible to a user without being generated by the display generation component, such a real world environment is “presented” to the user (e.g., allowed to be viewable, for example, via a transparent or translucent material) and not necessarily technically “displayed” to the user.

Additionally or alternatively, as used herein, the singular forms “a,” “an,” and “the” are intended to include the plural forms, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Further, although the above description uses terms “first,” “second,” etc. to describe various elements, these elements should not be limited by the terms. These terms are only used to distinguish one element from another. For example, a respective user interface could be referred to as a “first” or “second” user interface, without implying that the respective user interface has different characteristics based merely on the fact that the respective user interface is referred to as a “first” or “second” user interface. On the other hand, a user interface referred to as a “first” user interface and a user interface referred to as a “second” user interface are both user interface, but are not the same user interface, unless explicitly described as such.

Additionally or alternatively, as described herein, the term “if,” optionally, means “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. The terminology used in the description of the various described embodiments herein is for the purpose of describing particular embodiments only and is not intended to be limiting.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method, comprising:
at an electronic device in communication with a display and one or more input devices:
presenting, via the display, a computer-generated environment, wherein the computer-generated environment includes a first set of user interfaces that includes a first user interface and a second user interface, wherein the first set of user interfaces move together in response to movement inputs;
while presenting the computer-generated environment, receiving, via the one or more input devices, a user input corresponding to a request to move the first user interface; and
in response to receiving the user input corresponding to the request to move the first user interface:
changing a first orientation of the first user interface; and
changing a second orientation of the second user interface.

2. The method of claim 1, further comprising:
in response to receiving the user input corresponding to the request to move the first user interface:
moving the first user interface in accordance with the user input; and
moving the second user interface in accordance with the user input.

3. The method of claim 2, wherein:
in accordance with a determination that the request to move the first user interface includes a request to move the first user interface in a first direction:
moving the first user interface includes changing a size of the first user interface; and
moving the second user interface includes changing a size of the second user interface; and
in accordance with a determination that the request to move the first user interface includes a request to move the first user interface in a second direction, different from the first direction:
moving the first user interface includes moving the first user interface without changing a size of the first user interface; and
moving the second user interface includes moving the second user interface without changing a size of the second user interface.

4. The method of claim 3, wherein:
before receiving the request to move the first user interface in the first direction, the first user interface is a first distance from a user of the electronic device, and the second user interface is a first distance from the user, and
the request to move the first user interface in the first direction includes a request to change a depth of the first user interface from being the first distance from the user to being a second distance from the user, the method further comprising:
in accordance with the determination that the request to move the first user interface includes the request to move the first user interface in the first direction:
moving the first user interface from being the first distance from the user to being the second distance from the user; and
moving the second user interface from being the first distance from the user to being the second distance from the user.

5. The method of claim 3, further comprising:
in accordance with the determination that the request to move the first user interface includes the request to move the first user interface in the second direction:
moving the first user interface in the second direction without changing a distance from a user of the electronic device; and
moving the second user interface in the second direction without changing a distance from the user.

6. The method of claim 1, wherein changing a first orientation of the first user interface includes:
in accordance with a determination that the request to move the first user interface includes a request to move the first user interface in a first direction, rotating the first user interface in a first orientation; and
in accordance with a determination that the request to move the first user interface includes a request to move the first user interface in a second direction, different from the first direction, rotating the first user interface in a second orientation, different from the first orientation.

7. The method of claim 6, further comprising:
in response to receiving the user input corresponding to the request to move the first user interface:
in accordance with the determination that the request to move the first user interface includes the request to move the first user interface in the first direction, maintaining a distance between the first user interface and the second user interface; and
in accordance with the determination that the request to move the first user interface includes the request to move the first user interface in a second direction, changing a distance between a first part of the first user interface and a corresponding part of the second user interface.

8. The method of claim 6, wherein:
the request to move the first user interface in the first direction includes a request to move the first user interface horizontally in the computer-generated environment,
rotating the first user interface in the first orientation includes rotating the first user interface in a yaw orientation;
the request to move the first user interface in the second direction includes a request to move the first user interface vertically in the computer-generated environment; and
rotating the first user interface in the second orientation includes rotating the first user interface in a pitch orientation.

9. The method of claim 1, wherein receiving the user input corresponding to the request to move the first user interface includes detecting a selection gesture from a hand of the user directed at a movement affordance and a movement of the hand of the user while maintaining the selection gesture.

10. The method of claim 9, wherein the computer-generated environment includes one or more movement affordances of a first type and one or more movement affordances of a second type, wherein:
the one or more movement affordances of the first type are interactable to perform a first type of manipulation on the first user interface and the second user interface; and
the one or more movement affordances of the second type are interactable to perform a second type of manipulation on the first user interface and the second user interface.

11. The method of claim 9, wherein the computer-generated environment includes one or more movement affordances of a first type and one or more movement affordances of a second type, wherein:
the one or more movement affordances of the first type are interactable to perform a first type of manipulation and a second type of manipulation on the first user interface and the second user interface; and
the one or more movement affordances of the second type are interactable to manipulate a given user interface of the first user interface and second user interface, without manipulating an other user interface of the first user interface and second user interface.

12. The method of claim 10, wherein:
the first type of manipulation includes a movement in a first direction; and
the second type of manipulation includes a movement in a second direction, different from the first direction.

13. The method of claim 1, wherein:
before receiving the user input corresponding to the request to move the first user interface:
the first user interface has a first distance from a user of the electronic device; and
the second user interface has the first distance from the user; and
after receiving the user input corresponding to the request to move the first user interface:
the first user interface has a second distance from a user of the electronic device; and
the second user interface has the second distance from the user.

14. The method of claim 13, wherein the first distance and the second distance are a same distance.

15. The method of claim 1, wherein:
a normal vector of the first user interface is directed at a location in the computer-generated environment corresponding to a user of the electronic device; and
a normal vector of the second user interface is directed at the location in the computer-generated environment corresponding to the user.

16. The method of claim 1, wherein:
after receiving the user input corresponding to the request to move the first user interface:
a normal vector of the first user interface is directed at a location in the computer-generated environment corresponding to a user of the electronic device; and
a normal vector of the second user interface is directed at the location in the computer-generated environment corresponding to the user.

17. The method of claim 1, wherein the computer-generated environment includes a third user interface that is not a member of the first set of user interfaces, the method further comprising:
in response to receiving the user input corresponding to the request to move the first user interface, forgo changing an orientation of the third user interface.

18. An electronic device, comprising:
one or more processors;
memory; and
one or more programs, wherein the one or more programs are stored in the memory and configured to be executed by the one or more processors, the one or more programs including instructions for:
presenting, via a display, a computer-generated environment, wherein the computer-generated environment includes a first set of user interfaces that includes a first user interface and a second user interface, wherein the first set of user interfaces move together in response to movement inputs;
while presenting the computer-generated environment, receiving, via one or more input devices, a user input corresponding to a request to move the first user interface; and
in response to receiving the user input corresponding to the request to move the first user interface:
changing a first orientation of the first user interface; and
changing a second orientation of the second user interface.

19. A non-transitory computer readable storage medium storing one or more programs, the one or more programs comprising instructions, which when executed by one or more processors of an electronic device, cause the electronic device to:
one or more programs, wherein the one or more programs are stored in a memory and configured to be executed by the one or more processors, the one or more programs including instructions for:
presenting, via a display, a computer-generated environment, wherein the computer-generated environment includes a first set of user interfaces that includes a first user interface and a second user interface, wherein the first set of user interfaces move together in response to movement inputs;
while presenting the computer-generated environment, receiving, via one or more input devices, a user input corresponding to a request to move the first user interface; and
in response to receiving the user input corresponding to the request to move the first user interface:
changing a first orientation of the first user interface; and
changing a second orientation of the second user interface.
